(19) United States
(12) Patent Application Publication
(10) Pub. No.: US 2009/0253879 A1
(43) Pub. Date: Oct. 8, 2009

(54) POLYMER COMPOUND AND OIL ABSORBENT

(75) Inventors: Ryo Nishio, Kanagawa (JP); Naoyuki Hayashi, Kanagawa (JP); Takashi Kato, Kanagawa (JP); Ryojiro Akashi, Kanagawa (JP)

Correspondence Address: Moss & Burke, PLLC, 401 Holland Lane, Suite 407, Alexandria, VA, 22314, US

(73) Assignees: FUJIFILM CORPORATION, Tokyo (JP); FUJI XEROX CO., LTD., Tokyo (JP)

(21) Appl. No.: 12/409,534

(22) Filed: Mar. 24, 2009

(30) Foreign Application Priority Data
Mar. 31, 2008 (JP) 2008-093707

(51) Int. Cl. C08J 9/00

(52) U.S. Cl. 526/258

(57) ABSTRACT

The present invention provides a polymer compound having a repeating structure represented by the following Formula (1) or Formula (3). In Formula (1) or Formula (3), R¹, R² and R³ each independently represent a hydrogen atom or an alkyl group; and R⁴ represents a straight-chained or branched alkyl group having 10 or more carbon atoms. X¹ and X² each represent a divalent linking group. x, y and z each represent mole %, and satisfy the conditions of 0<x≦90, 0<y≦90, 0<z≦2.5, and 70≦x+y+z≦100. B represents a quaternary ammonium ion, in which at least one alkyl group having 10 or more carbon atoms is bonded to the nitrogen atom of the quaternary ammonium ion, or a cation with delocalized charge; and A represents a counter anion therefor. D represents a phosphoric acid ion which may be alkyl-substituted, a phosphonic acid ion, a carboxylic acid ion, a sulfuric acid ion, a sulfite ion, or the following Anion (II), (III) or (IV); and E represents a counter cation therefor.

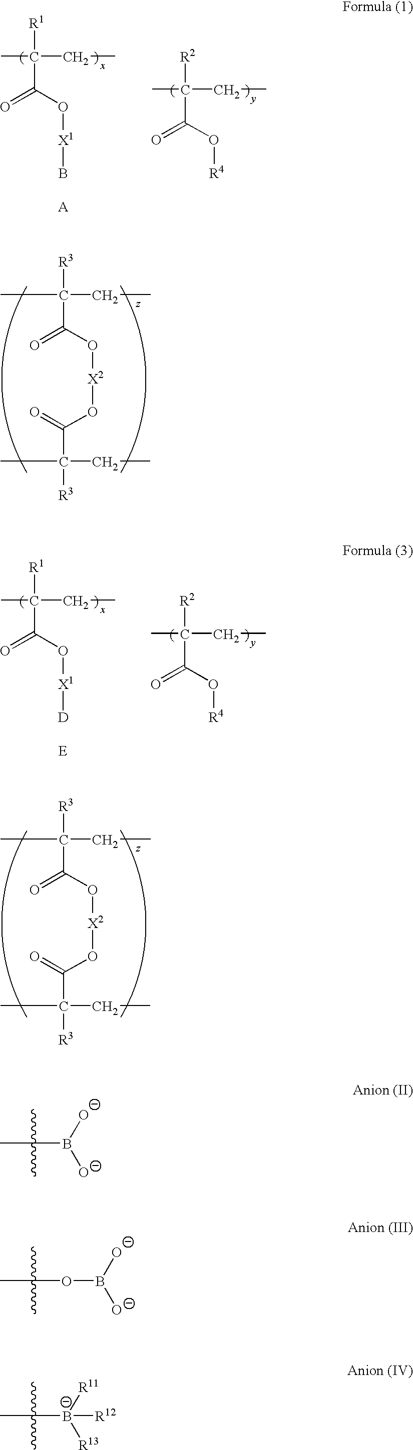

### CROSS REFERENCE TO RELATED APPLICATIONS

This application claims priority under 35USC 119 from Japanese Patent Application No. 2008-093707, the disclosure of which is incorporated herein by reference.

### BACKGROUND OF THE INVENTION

1. Field of the Invention

The present invention relates to a polymer compound and an oil absorbent.

2. Description of the Related Art

Although polymer materials (hydrogel) which absorb water are generally well known, there are comparatively few known examples regarding polymer materials (organogel, lipogel) which absorb oil. However, the recovery performance of marine spillage oil or waste oil has become controversial as an environmental issue, and the use of organogel for oil recovery has been studied in recent years.

However, most conventional oil absorbents are inconvenient for handling because the conventional oil absorbents are difficult to mold due to being low molecular weight absorbents formed of amino acids or the like, and are apt to spread out due to their powdery form, or are soluble in water.

On the other hand, polymer type oil absorbents are mostly formed by hydrophobicizing simple hydrophilic gel (for example, refer to Japanese Patent Application Laid-Open (JP-A) No. 2007-222728), and the amount of oil absorption (weight ratio) of the polymer type oil absorbents is about three to ten at a maximum, and thus, the absorbents are insufficient for being put to practical use.

Further, synthetic polymer type oil absorbents such as an un-crosslinked styrene-butadiene type copolymer are restricted in the kind of oils to be applied, and the usage of the absorbents is troublesome as operations such as heating or mixing are required at the time of oil absorption. Moreover, there are problems that the shape-maintainability of the absorbent is insufficient, and the recovery thereof is difficult.

In addition, as polymer type oil absorbents, there have been proposed, for example, ring-opened polymers of norbornnene or derivatives thereof (for example, JP-A No. 6-279571), and acrylic crosslinked polymers (for example, JP-A No. 5-15777). However, the amount of oil absorption by these oil absorbents is insufficient.

On the other hand, a hydrophobic gel having a specific structure with an ionic group is proposed in Nature Materials, Vol. 6, pp. 429-433 (2007), and a high oil absorption amount is obtained as compared with conventional oil absorbents.

However, this hydrophobic gel has a high oil absorbability for a solvent such as dichloromethane or tetrahydrofuran (THF) having a dielectric constant ∈ of approximately 10, but still has a low amount of oil absorption for oils such as various kinds of oils for industrial use and oils for home cooking use, which have a lower dielectric constant ∈, and accordingly, development of organogel with a sufficient amount of oil absorption for practical use has been desired.

### SUMMARY OF THE INVENTION

A first aspect of the present invention, there is provided a polymer compound having a repeating structure represented by the following Formula (1):

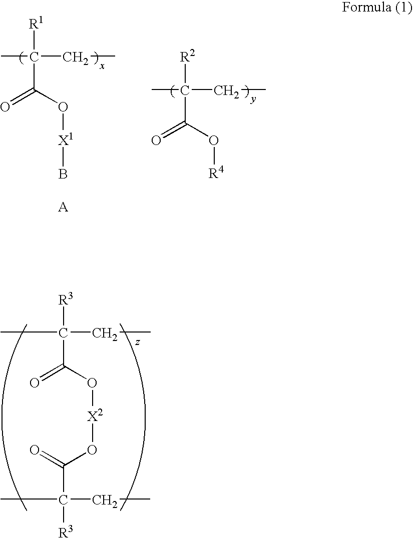

In Formula (1), R¹, R² and R³ each independently represent a hydrogen atom or an alkyl group; R⁴ represents a straight-chained, branched or cyclic alkyl group having 10 or more carbon atoms. X¹ and X² each independently represent a divalent linking group. B represents a quaternary ammonium ion, in which at least one alkyl group having 10 or more carbon atoms is bonded to the nitrogen atom of the quaternary ammonium ion, or a cation with delocalized charge; A represents a counter anion therefor. x, y and z each represent mole %, and satisfy the following conditions; 0<x≦90, 0<y≦90, 0<z≦2.5, and 70≦x+y+z≦100.

A second aspect of the present invention, there is provided a polymer compound having a repeating structure represented by the following Formula (3):

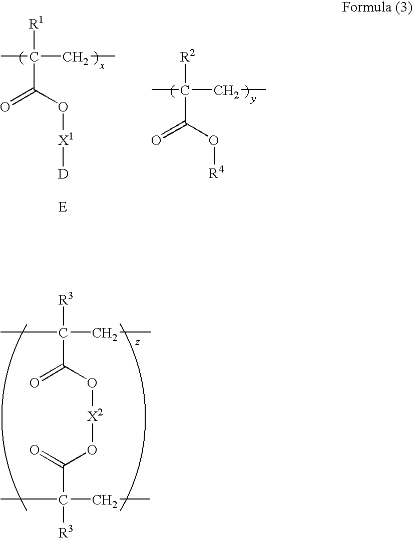

In Formula (3), R¹, R² and R³ each independently represent a hydrogen atom or an alkyl group; R⁴ represents a straight-chained, branched or cyclic alkyl group having 10 or more carbon atoms; X¹ and X² each independently represent a divalent linking group; D represents a phosphoric acid ion which may be alkyl-substituted, a phosphonic acid ion which may be alkyl-substituted, a carboxylic acid ion, a sulfite ion, a sulfuric acid ion, the following Anion (II) which may be alkyl-substituted, the following Anion (III) which may be alkyl-substituted, or the following Anion (IV); E represents a counter anion therefor; and x, y and z each represent mole %, and satisfy the following conditions; 0<x≦90, 0<y≦90, 0<z≦2.5, and 70≦x+y+z≦100;

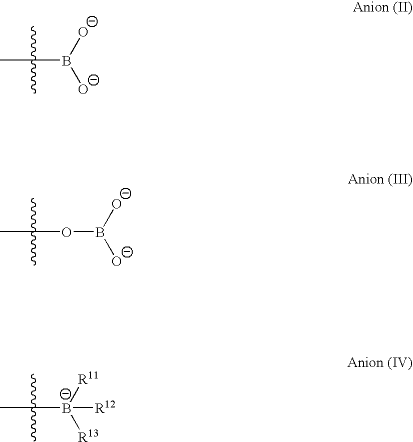

The wavy lines in Anion (II), (III) and (IV) represent the bonding position to X¹ in Formula (3). R¹¹, R¹² and R¹³ in Anion (IV) each independently represent an aromatic ring group which may have a substituent, a halogen atom or an alkyl group which may have a substituent.

A third aspect of the present invention, there is provided an oil absorbent containing the polymer compound according to the first aspect or the second aspect.

### BRIEF DESCRIPTION OF THE DRAWING

FIG. 1 is a graph illustrating the result of Example 5.

### DETAILED DESCRIPTION OF THE INVENTION

The polymer compound of the present invention has a high amount of oil absorption for industrial use oils such as gasoline, heavy fuel oil, crude oil, kerosene, gas oil and ISOPAR M ((registered trademark) manufactured by Exxon Mobil Corporation), and for home use cooking oils such as salad oil, rapeseed oil, soybean oil and olive oil. The polymer compounds of the present invention have a specific structure so as to exhibit a high amount oil absorption for the oils having such a low dielectric constant ∈.

Although cross-linkable polymer compounds which absorb a solvent may be called, in general, polymer gels including the state before absorbing the solvent and the state after absorbing the solvent, the polymer compounds in the present invention include such polymer gels. Further, the polymer compound is synonymous with the polymer gel in the present invention, irrespective of whether the polymer compound or the polymer gel contains a solvent. Hereinafter, the polymer compound will be explained in detail.

As a result of enthusiastic study by the present inventors, it has become clear that amount of oil absorption can be increased by the polymer gels in which the following points are improved:

(1) introducing a long chain alkyl group to a polymer compound, in order to enhance the affinity for oil;
(2) introducing an ionic group to a polymer compound, in order to raise the swelling property of the polymer compound in oil by taking advantage of the osmotic pressure difference due to ionic dissociation; and
(3) reducing cross-linked density and increasing molecular weight of a polymer compound, in order to increasing a swelling rate (amount of oil absorption) of the polymer compound.

As a result of further enthusiastic study by the present inventors, it has been found that the suitable position for introducing the long chain alkyl group is in the vicinity of the ionic group. Furthermore, it has been found that for the ionic group and the counter ion, those in which charges are widely distributed and delocalized, are preferable.

According to the present invention, there can be provided polymer compounds having a high amount oil absorption for industrial use oils and home cooking use oils, and oil absorbents using the polymer compounds.

Hereinafter, the present invention will be described in detail. The denotation “to” in this specification, means the numerals before and after “to”, both inclusive as the minimum value and the maximum value, respectively.

<First Polymer Gel>

A first polymer compound of the present invention is a polymer compound having a repeating structure represented by the following Formula (1);

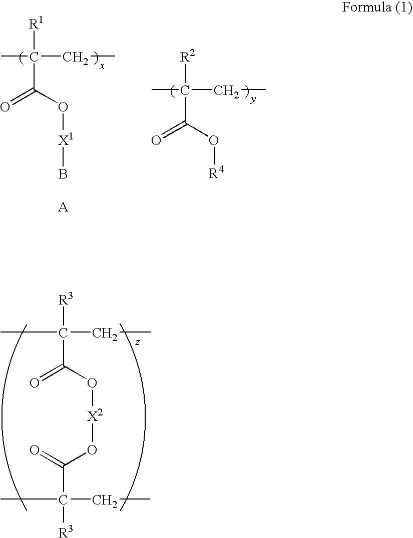

In Formula (1), R¹, R² and R³ each independently represent a hydrogen atom or an alkyl group; R⁴ represents a straight-chained, branched or cyclic alkyl group having 10 or more carbon atoms. X¹ and X² each independently represent a divalent linking group. B represents a quaternary ammonium ion, in which at least one alkyl group having 10 or more carbon atoms is bonded to the nitrogen atom of the quaternary ammonium ion, or a cation with delocalized charge; A represents a counter anion therefor. x, y and z each represent mole %, and satisfy the following conditions; 0<x≦90, 0≦y≦90, 0<z≦2.5, and 70≦x+y+z≦100.

In Formula (1), B represents a quaternary ammonium ion, in which at least one alkyl group having 10 or more carbon atoms is bonded to the nitrogen atom of the quaternary ammonium ion, or a cation with delocalized charge.

As is represented by B, when a hydrophobic moiety exists in the vicinity of a quaternary ammonium ion, the amount of oil absorption of the polymer gel increases. Although the reason for this is not clear, it is presumed to be as follows. However, the present invention is not restricted by this presumption.

When the quaternary ammonium salt is dissociated to form a quaternary ammonium ion, the osmotic pressure inside a gel becomes higher and oil tends to penetrate into the inside of the gel. At this time, it is presumed that since a hydrophobic group with a high affinity for the oil exists in the vicinity of the quaternary ammonium ion, the oil is attracted to the inside of the gel.

Accordingly, the amount of oil absorption is increased in the case where a hydrophobic group is introduced into the vicinity of the ionic group as compared with the case where the hydrophobic is introduced at a position apart from the ionic group.

In the present invention, such a structure where a hydrophobic moiety exists in the vicinity of the ionic group is a quaternary ammonium ion, in which at least one alkyl group having 10 or more carbon atoms is bonded to the nitrogen atom of the quaternary ammonium ion, is more preferably a quaternary ammonium ion, in which at least one alkyl group having 10 to 55 carbon atoms is bonded to the nitrogen atom of the quaternary ammonium ion, and is further more preferably a quaternary ammonium ion, in which at least one alkyl group having 12 to 22 carbon atoms is bonded to the nitrogen atom of the quaternary ammonium ion.

The alkyl group having 10 or more carbon atoms bonded to the nitrogen atom of the quaternary ammonium may be any of straight-chained, branched and cyclic alkyl groups, but is preferably straight-chained or branched, and more preferably a straight alkyl group in view of the degree of the affinity (hydrophobic interaction) for a hydrophobic solvent.

One or more of the alkyl groups having 10 or more carbon atoms may be bonded to the nitrogen atom of a quaternary ammonium, and up to three alkyl groups may be bonded to the nitrogen atom. The case where two or three alkyl groups are bonded to the nitrogen atom is preferable.

On the other hand, when B is a cation with delocalized charge, the amount of oil absorption increases. Although the reason for this is not clear, it is presumed that when the charge is delocalized, the electrostatic interaction between A and B is lowered, ionic dissociation is promoted, and the osmotic pressure inside a gel is enhanced as compared with the osmotic pressure in the oil outside the gel, so that the penetration of oil into the inside from the outside of the gel is promoted. However, the present invention is not restricted by this presumption. In addition, in the present invention, “the charge is delocalized” means that the positive charge or negative charge does not exist on a single atom, but rather the charge is widely distributed over two or more atoms due to a resonance effect.

The cation represented by B with delocalized charge includes a heterocyclic ring, an iminium, a diazonium and a cation of a non-cyclic nitrogen skeleton, in which the charges are delocalized, a cation of a trivalent carbon in the form of which a hydride ion is released from a carbon atom of an electrically neutral organic compound, and a cation of a pentavalent carbon in the form of which a proton is added to a carbon atom of an electrically neutral organic compound, but the heterocyclic ring with delocalized charge is preferable.

Examples of the heterocyclic ring with delocalized charge include, for example, a pyrrolium ion, a pyrazolium ion, a pyrrolidinium ion, an imidazolium ion, a triazolium ion, an isoxazolium ion, an oxazolium ion, a thiazolium ion, an isothiazolium ion, an oxadiazolium ion, an oxatriazolium ion, a dioxazolium ion, an oxathiazolium ion, an indolium ion, an indazolium ion, a benzopyrrolidinium ion, a benzimidazolium ion, a benzotriazolium ion, a benzoisoxazolium ion, a benzoxazolium ion, a benzothiazolium ion, a benzisothiazolium ion, a benzoxadiazolium ion, a benzoxatriazolium ion, a benzodioxazolium ion, a benzoxathiazolium ion, a carbozolium ion, a purinium ion, a pyridinium ion, a pyridadinium ion, a pyrimidinium ion, a pyradinium ion, a piperazinium ion, a triazinium ion, an oxazinium ion, a piperizinium ion, an oxathiazinium ion, an oxadiazinium ion, a morpholinium ion, an isoquinolinium ion, a quinolinium ion, a cinnolium ion, a quinazolinium ion, a benzopyrazinium ion, a benzopiperazinium ion, a benzotriazinium ion, a benzoxazinium ion, a benzopiperizinium ion, a benzoxathiazinium ion, a benzoxadizinium ion, a benzomorpholinium ion, a naphthylidinium ion, an acridinium ion, an azepinium ion and a diazepinium ion; preferably an imidazolium ion, a pyridinium ion, a piperizinium ion, a pyrrolidinium ion and an oxazolium ion; and more preferably, an imidazolium ion.

The heterocyclic rings with delocalized charge may have a substituent. The substituents may be a saturated or unsaturated hydrocarbon groups having a straight-chained, branched or cyclic structure (at this time, one or more —CH₂— may be replaced with —O—, —CO—, —CH═CH— or —C≡C—, under the condition that a hetero atom is not adjacent to the —CH₂— group), an aryl group, a halogen atom, a hydroxyl group, a carboxylic acid group, a sulfonic acid group or a phosphonic acid group; more preferably a saturated hydrocarbon group (alkyl group), an aryl group or a halogen atom; and further more preferably a saturated hydrocarbon group (alkyl group) or a halogen atom.

The number of the substituents, which a heterocyclic ring has, is not specifically restricted, but is preferably from 1 to 10, more preferably from 1 to 5, and further more preferably 1 to 3.

Although the substitution position of the substituent on the heterocyclic group is not specifically limited, in the case that the introduction of a substituent into the hetero atom of the heterocyclic ring is structurally acceptable, it is desirable that the hetero atom has a substituent from the viewpoint of the enhancement of the hydrophobicity or the resistance to the oxidation/reduction.

The heterocyclic ring with delocalized charge is particularly preferably the heterocyclic cation represented by the following Formula (2);

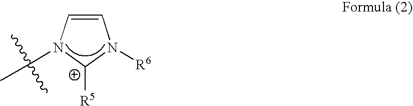

In Formula (2), R⁵ represents a hydrogen atom, or a straight-chained, branched or cyclic alkyl group. R⁶ represents a straight-chained, branched or cyclic alkyl group. The wavy line represents the bonding position to X¹.

The number of carbons of the straight-chained, branched or cyclic alkyl group represented by R⁵ in Formula (2) is preferably from 1 to 20, more preferably from 1 to 10, and still more preferably from 1 to 5. R⁵ is particularly preferably a straight-chained alkyl group having 1 to 3 carbon atoms.

The number of carbons of the straight-chained, branched or cyclic alkyl group represented by R⁶ in Formula (2) is preferably from 3 to 50, more preferably from 4 to 30, and still more preferably from 5 to 25. As R⁶, a straight-chained alkyl group having 10 to 20 carbon atoms is particularly preferable.

In Formula (1), A represents a counter anion. As the counter anion represented by A, a halogen ion, a phosphoric acid ion, a phosphonic acid ion, a carboxylic acid ion, a sulfite ion, a sulfuric acid ion, PF₆, SbF₆, N(SO₂CF₃)₂, ClO₄, SO₃CF₃, or Anion (I) shown below may be exemplified.

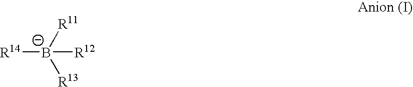

In Anion (I) in the above, R¹¹, R¹², R¹³ and R¹⁴ each independently represent an aromatic ring group which may have one or plural substituents, a halogen atom or an alkyl group which may have a substituent.

The aromatic group represented by R¹¹, R¹², R¹³ or R¹⁴ is preferably a phenyl group, a 1-naphthyl group, a 2-naphthyl group, a thiophene-2-il group, a thiophene-3-il group, a thiazole-2-il group, a thiazole-3-il group, a pyridine-2-il group, a pyridine-3-il group, a benzofuran-2-il group, a benzofuran-3-il group, a benzofuran-5-il group, a benzofuran-6-il, a benzothiophene-2-il group, a benzothiophene-5-il group, a benzothiophene-6-il group, a pyrimidine-2-il group, a pyrimidine-5-il group, a pyrazine-2-il group, a pyrazine-5-il group, a pyridazine-3-il group, a pyridazine-6-il group, an imidazole-2-il group, an imidazole 4-il group or an imidazole-5-il group; more preferably a phenyl group, a 1-naphthyl group, a 2-naphthyl group, a thiophene-2-il group, a thiophene-3-il group or an imidazole-2-il group; and still more preferably a phenyl group.

A substituent of the aromatic group represented by R¹¹, R¹², R¹³ or R¹⁴ is preferably an alkyl group, a fluoroalkyl group, an alkoxy group, an alkyloxy carbonyl group, an alkoxy carbonyl group, an alkyl carbonate group, an alkyl carbamate group, an alkyl urea group, an alkyl amide group, an alkyl imide group, a monoalkyl amino group, a dialkyl amino group, an alkyl thioether group or a halogen atom; more preferably an alkyl group having 1 to 30 carbon atoms, a fluoroalkyl group having 1 to 30 carbon atoms or a halogen atom; and still more preferably a methyl group an ethyl group, an isopropyl group, t-butyl group, a trifluoromethyl group, a fluorine atom, a chlorine atom, a bromine atom or an iodine atom.

The halogen atom represented by R¹¹, R¹³, R¹³ or R¹⁴ is preferably a fluorine atom, a chlorine atom, a bromine atom, or an iodine atom; and more preferably a fluorine atom.

The number of carbon atoms of the alkyl group represented by R¹¹, R¹², R¹³ or R¹⁴ is preferably from 1 to 30, more preferably from 3 to 22, and still more preferably from 6 to 18.

A substituent of the alkyl group represented by R¹¹, R¹², R¹³ or R¹⁴ is preferably a halogen atom, a phenyl group, a 1-naphthyl group, a 2-naphthyl group, an alkoxy group, an alkyloxy carbonyl group, an alkoxy carbonyl group, an alkyl carbonate group, an alkyl carbamate group, an alkylurea group, an alkylamide group, an alkylimide group, a monoalkylamino group, a dialkylamino group or an alkyl thioether group; more preferably a halogen atom, a phenyl group, a 1-naphthyl group, a 2-naphthyl group or an alkyl ether group; and still more preferably a halogen atom or a phenyl group.

Among them, as the aromatic ring group represented by R¹¹, R¹², R¹³ and R¹⁴, an unsubstituted aromatic ring group, an aromatic ring group substituted with a fluoroalkyl group having 1 to 22 carbon atoms, or an aromatic ring group substituted with a fluorine atom is preferable.

R¹¹, R¹², R¹³ and R¹⁴ may be the same or different, and from the viewpoint of the availability owing to the easiness of synthesis of Anion (I), it is suitable that R¹¹, R¹², R¹³ and R¹⁴ are the same.

Preferable examples of Anion (I) include tetraphenylborate, tetrakis (3, 5-bis(trifluoromethyl)phenyl) borate and tetrafluoroborate.

As the counter anion represented by A, the above Anion (I) or a halogen ion is preferable, and Anion (I) is more preferable, since the amount of oil absorption by polymer gel increases, when the charge is widely distributed and delocalized

R¹, R² and R³ in Formula (1) each independently represent a hydrogen atom or an alkyl group. The number of carbons of the alkyl group represented by R¹, R² and R³ is preferably from 1 to 6; more preferably from 1 to 3; and a methyl group is particularly preferable.

As R¹, R² and R³, a hydrogen atom or a methyl group is suitable, and a methyl group is more suitable from the viewpoint of the easiness of gelation.

R⁴ in Formula (1) represents a straight-chained, branched or cyclic alkyl group having 10 or more carbon atoms; preferably a straight-chained or branched alkyl group having 10 to 50 carbon atoms; more preferably a straight-chained or branched alkyl group having 10 to 36 carbon atoms; and still more preferably a straight-chained or branched alkyl group having 12 to 18.

The alkyl group represented by R⁴ may be any of straight-chained, branched and cyclic alkyl group, and a straight-chained alkyl group is suitable, in view of the ease of gelation and the large amount of oil absorption.

The alkyl group represented by R⁴ may have a substituent, and the alkyl group which does not have a substituent is suitable in view of the degree of the affinity (hydrophobic interaction) for a hydrophobic solvent.

X¹ and X² in Formula (1) each independently represent a divalent linking group.

X¹ in Formula (1) is preferably an alkylene group, a (poly)ethyleneoxy group, or a (poly) propyleneoxy group having 2 to 12 carbon atoms; more preferably an alkylene group having 2 to 10 carbon atoms; and still more preferably an alkylene group having 3 to 6 carbon atoms. In the case of the linking group with such a length, it is presumed that the distance from the polymer skeleton to the ionic group is appropriately separated, and the degree of swelling of the gel becomes higher.

X² in Formula (1) is preferably an alkylene group, (poly)ethyleneoxy group or (poly)propyleneoxy group having 2 to 50 carbon atoms; more preferably an alkylene group or (poly)ethyleneoxy group having 2 to 20 carbon atoms; and still more preferably an alkylene group having 3 to 8 carbon atoms.

x, y and z in Formula (1) each represent mole %, and satisfy the conditions; 0<x≦90, 0<y≦90, 0<z≦2.5, and 70≦x+y+z≦100, respectively.

The value of x in Formula (1) means the introduction rate of ionic groups. As the number of ionic groups is increased, the difference of osmotic pressure becomes large when the polymer represented by Formula (1) is ionically dissociated, so that the amount of oil absorption can be raised.

The value of y in Formula (1) means the introduction rate of hydrophobic monomers. As the rate of y is increased, the degree of swelling (affinity) in a hydrophobic solvent is improved.

The value of z in Formula (1) means the introduction rate of cross-linking groups. As the rate of z is reduced, the cross-linking density is lowered, and the degree of swelling in a solvent is improved. In order to reduce the cross-linking density, it is effective that z is reduced, or X² is increased in Formulae (1) and (2). In particular, in the present invention, it is preferable that z is 0.8% by mass or less to reduce the cross-linking density.

In the polymer gel of the present invention, the amount of oil absorption is increased, whereby the degree of ionic dissociation is increased, the affinity for a hydrophobic solvent is enhanced, and a cross-linking density is reduced. Accordingly, two parameters of the degree of ionic dissociation dominated by the rate of x, and the affinity for the hydrophobic solvent dominated by the rate of y have a trade-off relationship with each other.

From such a relationship, the ratio of suitable x, y and z is expressed as follows:

The range of x is preferably from 1 mole % to 50 mole %, more preferably from 5 mole % to 40 mole %, and still more preferably from 10 mole % to 30 mole %.

The range of y is preferably from 50 mole % to 90 mole %, more preferably from 60 mole % to 90 mole %, and still more preferably from 70 mole % to 90 mole %.

The range of z is preferably 0.95 mole % or less, more preferably 0.8 mole %, further more preferably from 0.05 mole % to 0.6 mole %, and still more preferably from 0.1 mole % to 0.6 mole %.

x, y, and z in the polymer gel can be identified by the solid NMR analysis of the dry gel after the gel is produced, or the solution NMR analysis of remained unreacted raw material after the gel is produced.

The total mole % (i.e., x+y+z) of x, y and z in Formula (1) is preferably in the range of from 70 mole % to 100 mole %, more preferably from 75 mole % to 100 mole %, further more preferably from 80 mole % to 100 mole %, and further more preferably from 85 mole % to 100 mole %.

The first polymer compound of the present invention may include other constituent units in addition to the constituent unit (x+y+z) represented by the Formula (1).

For example, when the constituent unit having a hydrophilic group is introduced, ionic dissociation is promoted and the amount of oil absorption by the polymer compound is increased. This is presumably due to the coordination of the hydrophilic group to the ionic group so that the dissociation of ion pair is promoted. However, the present invention is not restricted by this presumption.

As the hydrophilic moiety, a polyethyleneoxy group, a polypropyleneoxy group, a carboxyl group, a sulfo group, a hydroxyl group and a phosphoric acid group are preferable; a polyethyleneoxy group or a polypropyleneoxy group is more preferable; and a polyethyleneoxy group is still more preferable.

It is preferable that the polyethyleneoxy group or the polypropyleneoxy group has a hydrophobic group at the terminal end thereof from the viewpoint of the affinity for the hydrophobic solvent; and such a hydrophobic group is preferably a straight-chained, branched or cyclic alkyl group having 1 to 36 carbon atoms, more preferably an alkyl group having 1 to 22 carbon atoms, and particularly preferably an alkyl group having 1 to 12 carbon atoms.

The number of repeating units of the polyethyleneoxy group is preferably from 2 to 15, more preferably from 2 to 10, and still more preferably from 4 to 8.

The number of carbons of polypropyleneoxy group is preferably from 2 to 12, more preferably from 2 to 8, and still more preferably from 4 to 6.

The amount of introduction of the constituent unit having a hydrophilic group is preferably from 5 mole % to 30 mole %, more preferably from 10 mole % to 25 mole %, and still more preferably from 15 mole % to 25 mole %.

The first polymer compound of the present invention including the constituent unit having a hydrophilic group is preferably a polymer compound having a repeating structure represented by the following Formula (1-1):

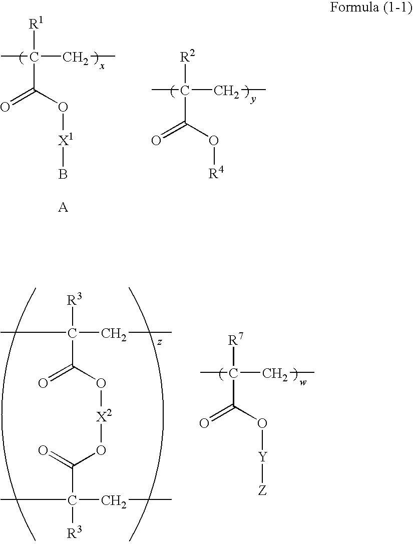

R¹, R², R³, R⁴, X¹, X², A and B in Formula (1-1) are synonymous with R¹, R², R³, R⁴, X¹, X², A and B in Formula (1), respectively. R⁷ is synonymous with R¹ to R³ in Formula (1). Y represents a polyethyleneoxy group or a polypropyleneoxy group. Z represents a straight-chained, branched or cyclic alkyl group, or a hydrogen atom. x, y, z and w each represent mole %, and satisfy the following conditions; 0<x≦90, 0<y≦90, 0<z≦2.5, 0<w<30 and 70≦x+y+z≦100.

As further other constituent units, styrene which may have a substituent, acrylamide which may have a substituent in addition to the above hydrophilic groups, may be exemplified.

The amount of introduction of these other constituent units is preferably from 0 mole % to less than 30 mole %, more preferably from 0 mole % to 20 mole %, still more preferably from 0 mole % to 15 mole %.

Hereinafter, specific examples of the polymer structures according to the first polymer compounds are exemplified, but the present invention is not limited to these polymer structures.

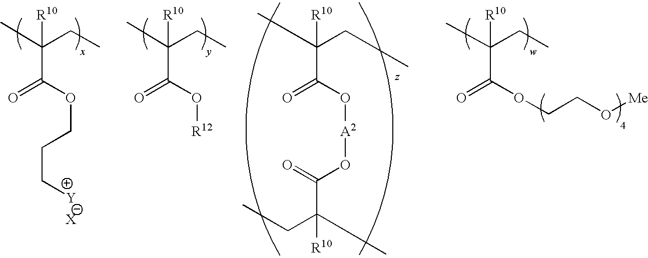

| No. | X^{⊖} | x | y | z | w | R¹⁰ | Y^{⊕} | R¹² | A² |
|---|---|---|---|---|---|---|---|---|---|
| 1 | ^{⊖}Br | 15 | 84.4 | 0.6 | 0 | H | ^{⊕}N(n-C₁₂H₂₅)₃ | n-C₁₈H₃₇ | —(CH₂)₂— |
| 2 | ^{⊖}Br | 30 | 54.6 | 0.4 | 15 | Me | ^{⊕}N(n-C₁₂H₂₅)₃ | n-C₁₈H₃₇ | —(CH₂)₂— |
| 3 | ^{⊖}BPh₄ | 30 | 54.6 | 0.4 | 0 | Me | ^{⊕}N(n-C₁₈H₃₇)₃ | n-C₁₂H₃₇ | —(CH₂)₂— |
| 4 | ^{⊖}BPh₄ | 30 | 54.6 | 0.4 | 15 | Me | ^{⊕}N(n-C₁₂H₂₅)₃ | n-C₁₈H₃₇ | —(CH₂)₄— |
| 5 | ^{⊖}BPh₄ | 30 | 54.6 | 0.4 | 15 | Me | ^{⊕}N(n-C₁₂H₂₅)₃ | n-C₂₂H₄₅ | —(CH₂)₈— |
| 6 | ^{⊖}BPh₄ | 45 | 54.6 | 0.4 | 15 | H | ^{⊕}N(n-C₁₂H₂₅)Ph₂ | n-C₁₈H₃₇ | —(CH₂)₁₂— |
| 7 | ^{⊖}BPh₄ | 30 | 54.6 | 0.4 | 15 | Me | ^{⊕}N(n-C₁₈H₃₇)₃ | 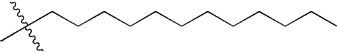 | —CH₂CH₂OCH₂CH₂— |
| | | | | | | | | 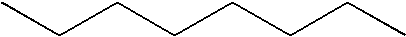 | |
| 8 | ^{⊖}BPh₄ | 30 | 54.6 | 0.4 | 15 | Me | ^{⊕}N(n-C₁₈H₃₇)₃ | n-C₂₂H₄₅ | —(CH₂CH₂O)₇CH₂CH₂— |
| 9 | ^{⊖}TFPB | 15 | 84.4 | 0.6 | 0 | Me | ^{⊕}N(n-C₁₂H₂₅)₃ | n-C₁₈H₃₇ | —(CH₂)₂— |
| 10 | ^{⊖}TFPB | 30 | 54.6 | 0.4 | 15 | H | ^{⊕}N(n-C₁₂H₂₅)₃ | 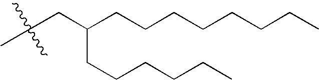 | —(CH₂)₂— |
| 11 | ^{⊖}TFPB | 30 | 54.6 | 0.4 | 15 | Me | ^{⊕}N(n-C₁₂H₂₅)Ph₂ | n-C₂₂H₄₅ | —(CH₂CH₂O)₃CH₂CH₂— |

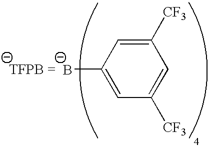

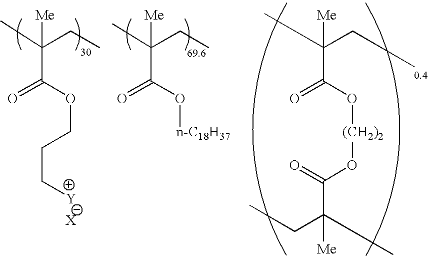

| No. | X^{⊖} | Y^{⊕} |
|---|---|---|
| 12 | Br⁻ | 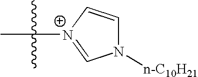 |
| 13 | Br⁻ | 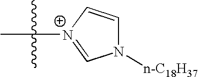 |
| 14 | ⁻BPh₄ | 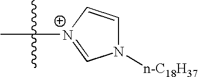 |
| 15 | ⁻BPh₄ | 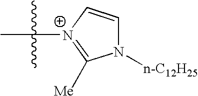 |
| 16 | Br⁻ | 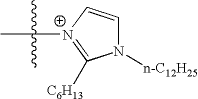 |
| 17 | ⁻TFPB | 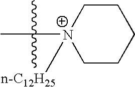 |
| 18 | ⁻BPh₄ | 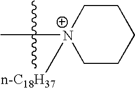 |

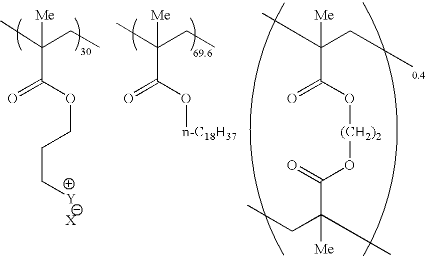

| No. | X^{⊖} | Y^{⊕} |
|---|---|---|
| 19 | ⁻BPh₄ | 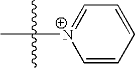 |
| 20 | ⁻BPh₄ | 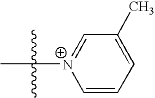 |
| 21 | ⁻BPh₄ | 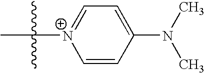 |
| 22 | ⁻BPh₄ | 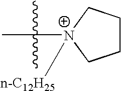 |
| 23 | ⁻BPh₄ | 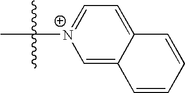 |
| 24 | ⁻BPh₄ | 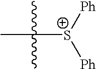 |

<Second Polymer Gel>

The second polymer gel of the present invention is a polymer gel having a repeating structure represented by the following Formula (3):

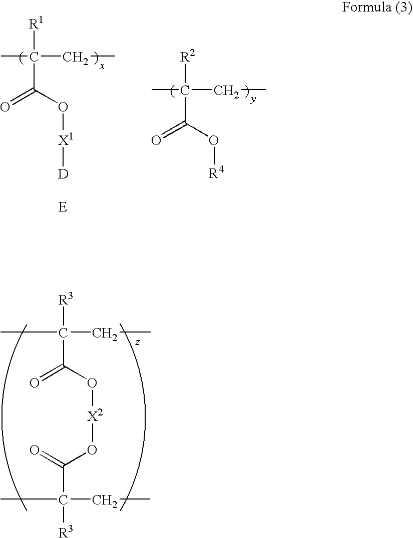

In Formula (3), R¹, R² and R³ each independently represent a hydrogen atom or an alkyl group; and R⁴ represents a straight-chained, branched or cyclic alkyl group having 10 or more carbon atoms. X¹ and X² each independently represent a divalent linking group. D represents a phosphoric acid ion which may be alkyl-substituted, a phosphonic acid ion which may be alkyl-substituted, a carboxylic acid ion, a sulfite ion, a sulfuric acid ion, the following Anion (II) which may be alkyl-substituted, the following Anion (III) which may alkyl-substituted, or Anion (IV); and E represents a counter cation therefor. x, y and z each represent mole %, and satisfy the following conditions; 0<x≦90, 0<y≦90, 0<z≦2.5, and 70≦x+y+z≦100.

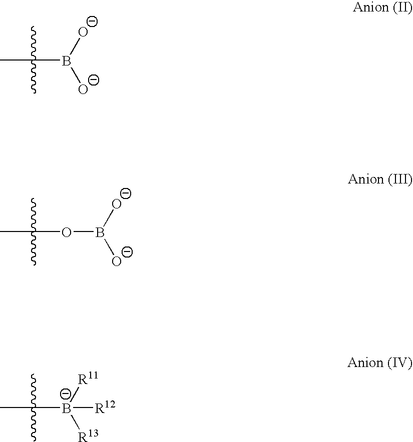

The wavy lines in the above Anions (II), (III) and (IV) represent the bonding position to X¹ in Formula (3).

In Anion (IV), R¹¹, R¹² and R¹³ are synonymous with R¹¹, R¹² and R¹³ in Anion (I), respectively, and the suitable ranges are also the same as those of Anion (I).

R¹, R², R³, R⁴, X¹ and X² in Formula (3) are synonymous with R¹, R², R³, R⁴, X¹ and X² in Formula (1), respectively, and the suitable ranges are also the same as those of Formula (1).

D in Formula (3) represents a phosphoric acid ion which may be alkyl-substituted, a phosphonic acid ion which may be alkyl-substituted, a carboxylic acid ion, a sulfite ion, a sulfuric acid ion, Anion (II) which may be alkyl-substituted, Anion (III) which may be alkyl-substituted, or Anion (IV); and preferably is an alkyl-substituted Anion (II) or a carboxylic acid ion.

The alkyl group as a substituent of the phosphoric acid ion, the phosphonic acid ion, Anion (II), Anion (III) has preferably 1 to 40 carbon atoms, more preferably 3 to 30 carbon atoms, and still more preferably 5 to 22 carbon atoms. The alkyl group may be straight-chained, branched or cyclic, and the straight-chained alkyl group is preferable from viewpoint of the high degree of the affinity (hydrophobic interaction) for a hydrophobic solvent.

The alkyl-substituted phosphoric acid ion, phosphonic acid ion, Anion (II) and Anion (III) mean the following ion.

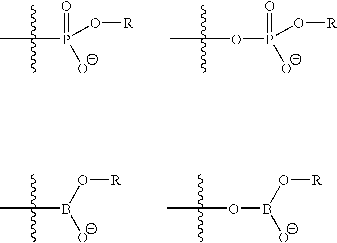

In the above Formula, R represents the alkyl group as a substituent of the phosphoric acid ion, the phosphonic acid ion, Anion (II) or Anion (III).

E in Formula (3) represents a counter cation, and is an atom of the group I (alkali metal atom) of the periodic table, an atom of the group II (alkaline earth metal atom) of the periodic table, a quaternary ammonium ion, a pyrrolium ion, a pyrazolium ion, a pyrrolidinium ion, an imidazolium ion, a triazolium ion, an isoxazolium ion, an oxazolium ion, a thiazolium ion, an isothiazolium ion, an oxadiazolium ion, an oxatriazolium ion, a dioxazolium ion, an oxathiazolium ion, an indolium ion, an indazolium ion, a benzopyrrolidinium ion, a benzimidazolium ion, a benzotriazolium ion, a benzoisoxazolium ion, a benzoxazolium ion, a benzothiazolium ion, a benzisothiazolium ion, a benzoxadiazolium ion, a benzoxatriazolium ion, a benzodioxazolium ion, a benzoxathiazolium ion, a carbozolium ion, a purinium ion, a pyridinium ion, a pyridadinium ion, a pyrimidinium ion, a pyradinium ion, a piperazinium ion, a triazinium ion, an oxazinium ion, a piperizinium ion, an oxathiazinium ion, an oxadiazinium ion, a morpholinium ion, an isoquinolinium ion, a quinolinium ion, a cinnolium ion, a quinazolinium ion, a benzopyrazinium ion, a benzopiperazinium ion, a benzotriazinium ion, a benzoxazinium ion, a benzopiperizinium ion, a benzoxathiazonium ion, a benzoxadizinium ion, a benzomorpholinium ion, a naphthylidinium ion, an acridinium ion, an azepinium ion and a diazepinium ion.

In addition, these ions may be unsubstituted, or substituted with an alkyl group, an aryl group, an acyl group, an alkoxy group, an aryloxy group, a halo group, a mercapto group, an amino group, a hydroxyl group, an azo group, a cyano group, a carboxyl group, an alkoxycarbonyl group, an aryloxy carbonyl group, a halocarbonyl group, or a combination therewith.

Among them, E in Formula (3) is preferably a quaternary ammonium ion or a cation with delocalized charge for increasing the amount of oil absorption.

The quaternary ammonium ion represented by E is preferably a quaternary ammonium ion in which at least one alkyl group is bonded to the nitrogen atom of the quaternary ammonium ion, and the alkyl group bonded to the nitrogen atom has preferably 1 to 30 carbon atoms, more preferably 3 to 22 carbon atoms, and still more preferably 6 to 18 carbon atoms.

The alkyl group bonded to the nitrogen atom of the quaternary ammonium may be any of straight-chained, branched and cyclic alkyl groups; preferably a straight-chained or a branched alkyl group; and more preferably a straight-chained alkyl group from the viewpoint of the high degree of the affinity (hydrophobic interaction) for a hydrophobic solvent.

One or more of alkyl groups may be bonded to the nitrogen atom of the quaternary ammonium, and up to four alkyl groups may be bonded to the nitrogen atom, and two to four alkyl groups are preferably bonded to the nitrogen atom.

The cation represented by E with delocalized charge includes a heterocyclic ring, an iminium, a diazonium and a cation of a non-cyclic nitrogen skeleton, in which the charges are delocalized, a cation of a trivalent carbon in the form of which a hydride ion is released from a carbon atom of an electrically neutral organic compound, and a cation of a pentavalent carbon in the form of which a proton is added to a carbon atom of an electrically neutral organic compound, and the heterocyclic ring with delocalized charge is preferable.

Examples of the heterocyclic ring with delocalized charge include, for example, a pyrrolium ion, a pyrazolium ion, a pyrrolidinium ion, an imidazolium ion, a triazolium ion, an isoxazolium ion, an oxazolium ion, a thiazolium ion, an isothiazolium ion, an oxadiazolium ion, an oxatriazolium ion, a dioxazolium ion, an oxathiazolium ion, an indolium ion, an indazolium ion, a benzopyrrolidinium ion, a benzimidazolium ion, a benzotriazolium ion, a benzoisoxazolium ion, a benzoxazolium ion, a benzothiazolium ion, a benzisothiazolium ion, a benzoxadiazolium ion, a benzoxatriazolium ion, a benzodioxazolium ion, a benzoxathiazolium ion, a carbozolium ion, a purinium ion, a pyridinium ion, a pyridadinium ion, a pyrimidinium ion, a pyradinium ion, a piperazinium ion, a triazinium ion, an oxazinium ion, a piperizinium ion, an oxathiazinium ion, an oxadiazinium ion, a morpholinium ion, an isoquinolinium ion, a quinolinium ion, a cinnolium ion, a quinazolinium ion, a benzopyrazinium ion, a benzopiperazinium ion, a benzotriazinium ion, a benzoxazinium ion, a benzopiperizinium ion, a benzoxathiazonium ion, a benzoxadizinium ion, a benzomorpholinium ion, a naphthylidinium ion, an acridinium ion, an azepinium ion and a diazepinium ion; preferably an imidazolium ion, a pyridinium ion, a piperizinium ion, a pyrrolidinium ion and an oxazolium ion; and more preferably, an imidazolium ion.

The heterocyclic rings with delocalized charge may have a substituent. The substituents may be a saturated or unsaturated hydrocarbon group having a straight-chained, branched or cyclic structure (at this time, one or more —CH₂— may be replaced with —O—, —CO—, —CH═CH— or —C≡C—, under the condition that a hetero atom is not adjacent to the —CH₂— group), an aryl group, a halogen atom, a hydroxyl group, a carboxylic acid group, a sulfonic acid group or a phosphonic acid group; preferably a saturated hydrocarbon group (alkyl group), an aryl group or a halogen atom; and more preferably a saturated hydrocarbon group (alkyl group) or a halogen atom.

The number of the substituents, which a heterocyclic ring has, is not specifically restricted, but is preferably from 1 to 10, more preferably from 1 to 5, and further more preferably 1 to 3.

The substitution position of the substituent on the heterocyclic group is not specifically limited. In the case that the introduction of a substituent into the hetero atom of the heterocyclic ring is structurally acceptable, it is preferable that the hetero atom has a substituent.

The heterocyclic ring with delocalized charge is particularly preferably the heterocyclic cation represented by the following Formula (4);

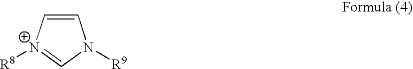

In Formula (4), R⁸ and R⁹ represent a straight-chained, branched or cyclic alkyl group. R⁸ and R⁹ are synonymous with R⁶ in Formula (2), and the preferable range is the same as that of R⁶.

x, y and z in Formula (3) each independently represent mole %, and satisfy the conditions; 0<x≦90, 0<y≦90, 0<z≦2.5, and 70≦x+y+z≦100, respectively. The preferable ratio of x, y and z is as follows:

The range of x is preferably from 1 mole % to 50 mole %, more preferably from 5 mole % to 40 mole %, and still more preferably from 15 mole % to 35 mole %.

The range of y is preferably from 50 mole % to 90 mole %, more preferably from 60 mole % to 90 mole %, and still more preferably from 65 mole % to 90 mole %.

The range of z is preferably 0.95 mole % or less, more preferably 0.8 mole %, further more preferably from 0.05 mole % to 0.7 mole %, and still more preferably from 0.1 mole % to 0.6 mole %.

The total mole % (i.e., x+y+z) of x, y and z in Formula (3) is in the range of from 70 mole % to 100 mole %, more preferably from 75 mole % to 100 mole %, further more preferably from 80 mole % to 100 mole %, and further more preferably from 85 mole % to 100 mole %.

The second polymer compound of the present invention may include other constituent units in addition to the constituent unit (x+y+z) represented by Formula (3).

For example, when a constituent unit having a hydrophilic group is introduced, ionic dissociation is promoted and the amount of oil absorption by the polymer compound is increased. This is presumably due to the coordination of the hydrophilic group to the ionic group so that the dissociation of ion pair is promoted. However, the present invention is not restricted by this presumption.

As the hydrophilic moiety, the hydrophilic group as described in the first polymer gel is suitable, and the suitable range is also similar thereto.

The second polymer compound containing a hydrophilic constituent group of the present invention is suitably represented by the following Formula (3-1).

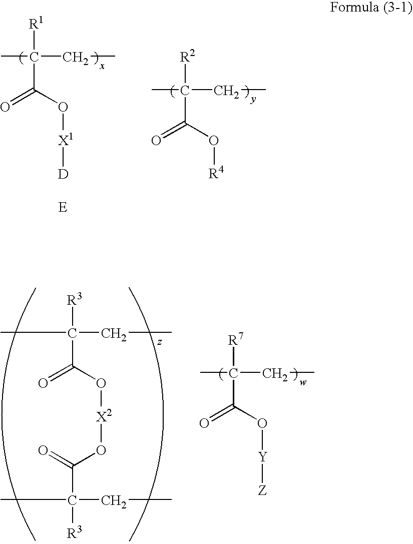

R¹, R², R³, R⁴, X¹, X², D and E in Formula (3-1) are synonymous with R¹, R², R³, R⁴, X¹, X², D and E in Formula (3), respectively. R⁷ is synonymous with R¹ to R³ in Formula (3). Y represents a polyethyleneoxy group or a polypropyleneoxy group. Z represents a straight-chained, branched or cyclic alkyl group, or a hydrogen atom. x, y, z and w each independently represent mole %, and satisfy the following conditions; 0<x≦90, 0<y≦90, 0<z≦2.5, 0<w<30 and 70≦x+y+z<100.

As further other constituent units, styrene which may have a substituent, acrylamide which may have a substituent in addition to the above hydrophilic groups, may be exemplified.

The amount of introduction of these other constituent units is preferably from 0 mole % to less than 30 mole %, more preferably from 0 mole % to 20 mole %, still more preferably from 0 mole % to 15 mole %.

Hereinafter, specific examples of the polymer structures according to the second polymer gel are exemplified, but the present invention is not limited to these polymer structures.

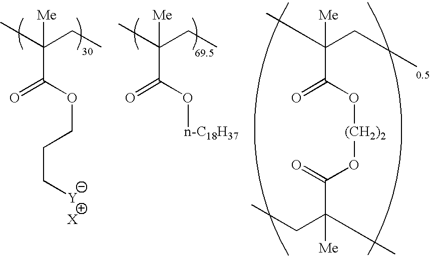

| No. | X^{⊕} | Y^{⊖} |
|---|---|---|
| 25 | ^{⊕}N(CH₃)(n-C₁₂H₂₅)₃ | 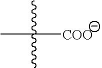 |
| 26 | ^{⊕}P(CH₃)(n-C₆H₁₃)₃ | 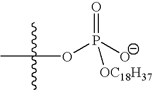 |
| 27 | 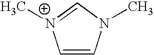 | 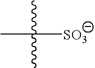 |
| 28 | 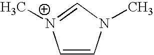 | 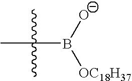 |
| 29 | 2 ^{⊕}N(CH₃)(n-C₁₈H₃₇)₃ | 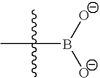 |

The polymer gel can be manufactured by known polymerization methods such as a liquid polymerization method, an emulsion polymerization method, a suspension polymerization method, a dispersion polymerization method, a seed polymerization method, a template polymerization, a plasma polymerization method, a bulk polymerization method, a dope polymerization method, chemical oxidative polymerization method, an electrolytic polymerization method, a sedimentation polymerization method, a precipitation polymerization method, a photopolymerization method, a microemulsion polymerization method, a miniemulsion polymerization method, an interfacial gel polymerization method and a soap-less (soap free) polymerization method.

In the present invention, the polymerization reaction is carried out preferably in the presence of a non-metal polymerization initiator. For example, a compound having polymerizable carbon-carbon double bonds can be polymerized in the presence of a polymerization initiator that exhibits an activity by generating free radicals such as a carbon radical and an oxygen radical by heating.

As the polymerization initiator, an organic peroxide or an organic azo compound is preferably used, and an organic azo compound is more preferable. However, the polymerization initiator used in the present invention is not limited to these polymerization initiators.

The organic azo compounds include azo nitrile compounds such as V-30, V-40, V-59, V-65 and V-70; azo amide compounds such as VA-080, VA-085, VA-086, VF-096, VAm-110 and VAm-111; cyclic azo amidine compounds such as VA-044 and VA-061; and azo amidine compounds such as V-50 and VA-057 ((trade names) commercially available from Wako Pure Chemical Industries, Ltd.); 2,2-azobis(4-methoxy-2,4-dimethylvaleronitrile), 2,2-azobis(2,4-dimethylvaleronitrile), 2,2-azobis(2-methylpropionitrile), 2,2-azobis(2,4-dimethylbutylonitrile), 1,1-azobis(cyclohexane-1-carbonitrile), 1-[(1-cyano-1-methylethyl)azo]formamide, 2,2-azobis{2-methyl-N-[1,1-bis(hyroxymethyl)-2-hydroxyethyl]propionamide}, 2,2-azobis[2-methyl-N-(2-hydroxybutyl)propionamide], 2,2-azobis[N-(2-propenyl)-2-methylpropionamide], 2,2-azobis(N-butyl-2-methylpropionamide), 2,2-azobis(N-cyclohexyl-2-methylpropionamide), 2,2-azobis[2-(2-imidazoline-2-il)propane]dihydrochloride, 2,2-azobis[2-(2-imidazoline-2-il)propane]disulfatedihydrate, 2,2-azobis{2-[1-(2-hydroxyethyl)-2-imidazoline-2-il]propane}dihydrochloride, 2,2-azobis[2-(2-imidazoline-2-il)propane], 2,2-azobis(1-imino-1-ppyrrolidino-2-methylpropane)dihydrochloride, 2,2-azobis(2-methylpropioneamidine)dihydrochloride, 2,2-azobis[N-(2-carboxyethyl)-2-methylpropioneamidine]tetrahydrate, dimethyl-2,2-azobis(2-methylpropionate), 4,4-azobis(4-cyanovaleric acid), and 2,2-azobis(2,4,4-trimethylpentane).

Preferable examples of organic peroxides include ketone peroxides such as PERHEXA H; peroxy ketals such as PERHEXA TMH, hydroperoxides such as PERBUTYL H-69, dialkyl peroxides such as PERCUMYL D, PERBUTYL C and PERBUTYL D, diacyl peroxides such as NYPER BW, peroxyesters such as PERBUTYL Z and PERBUTYL L, peroxydicarbonates such as PEROYL TCP ((all trade names) commercially available from NOF Corporation); diisobutyryl peroxide, cumylperoxy neodecanoate, di-n-propylperoxy dicarbonate, diisopropylperoxy dicarbonate, di-sec-butylperoxy dicarbonate, 1,1,3,3-tetramethylbutylperoxy neodecanoate, di(4-t-butylcyclohexyl)peroxy dicarbonate, di(2-ethylhexyl)peroxy dicarbonate, t-hexyl peroxy neodecanoate, t-butyl peroxy neodecanoate, t-butyl peroxy neoheptanate, t-hexyl peroxy pivalate, t-butyl peroxy pivalate, di(3,3,5-trimethyl hexanoyl)peroxide, dilauroyl peroxide, 1,1,3,3-tetramethyl butylperoxy-2-ethyhexanoate, disuccinic acid peroxide, 2,5-dimethyl-2,5-di(2-ethylhexanoylperoxy)hexane, t-hexylperoxy-2-ethylhexanoate, di(4-methylbenzoyl)peroxide, t-butylperoxy-2-ethylhexanoate, di(3-methylbenzoyl)peroxide, benzoyl(3-methylbenzoyl)peroxide, dibenzoylperoxide, 1,1-di(t-butylperoxy)-2-methylcyclohexane, 1,1-di(t-hexylperoxy)-3,3,5-trimethylcyclohexane, 1,1-di(t-hexylperoxy)cyclohexane, 1,1-di(t-butylperoxy)cyclohexane, 2,2-di(4,4-di(t-butylperoxy)cyclohexyl)propane, t-hexylperoxyisopropyl monocarbonate, t-butylperoxy maleic acid, t-butyperoxy-3,5,5-trimethyl hexanoate, t-butyulperoxy laurate, t-butylperoxy isopropyl monocarbonate, t-butylperoxy-2-ethylhexyl monocarbonate, t-hexylperoxy benzoate, 2,5-di-methyl-2,5-di(benzoylperoxy)hexane, t-butylperoxy acetate, 2,2-di(t-butylperoxy)butane, t-butylperoxy benzoate, n-butyl-4,4-di-t-butylperoxyvaleate, di(2-t-butylperoxyisopropyl)benzene, dicumyl peroxide, di-t-hexylperoxide, 2,5-dimethyl-2,5-di(t-butylperoxy)hexane, t-butylcumyl peroxide, di-t-butyl peroxide, p-methane hydroperoxide, 2,5-dimethyl-2,5-di(t-butylperoxy)hexine-3, diisopropyl benzene hydroperoxide, 1,1,3,3-tetramethylbutyl hydroperoxide, cumene hydroperoxide, t-butylhydroperoxide, 2,3-dimethyl-2,3-diphenyl butane, 2,4-dichlorobenzoyl peroxide, o-chhlorobenzoyl peroxide, p-chlorobenzoyl peroxide, tris-(t-butylperoxy)triazine, 2,4,4-trimethylpentylperoxy neodecanoate, α-cumylperoxy neodecanoate, t-amylperoxy-2-ethylhexanoate, t-butylperoxy isobutylate, di-t-butylperoxy hexahydroterephthalate, di-t-butylperoxy trimethyladipate, di-3-methoxybutylperoxy dicarbonate, di-isopropylperoxy dicarbonate, t-butylperoxy isopropylcarbonate, 1,6-bis(t-butylperoxycarbonyloxy)hexane, diethyleneglycol-bis(t-butylperoxycarbonate), and t-hexylperoxy neodecanoate.

In the present invention, the polymerization initiator may be used singly, or two or more kinds thereof may be used in combination. In the present invention, the use amount of the polymerization initiator is preferably from 0.001 mole % to 3 mole %, more preferably from 0.05 mole % to 2 mole %, and particularly preferably from 0.1 mole % to 1.5 mole %.

The optimal conditions of the polymerization reaction in the present invention vary with the kind of polymerization initiator, compound and solvent, concentration and the like. The temperature inside a reaction vessel is preferably from 0° C. to 150° C., more preferably from 20° C. to 100° C., and particularly preferably from 40° C. to 80° C., the reaction time of polymerization is preferably in the range of from 0.5 to 20 hours, more preferably from 1 to 12 hours, and particularly preferably from 1.5 to 8 hours.

Further, in order to prevent inactivation of polymerization initiator due to oxygen, the reaction is preferably carried out react under an inert gas atmosphere (for example, nitrogen, argon or the like), and the oxygen concentration at the time of the reaction is preferably 500 ppm or less, more preferably 200 ppm or less, and particularly preferably 100 ppm or less.

The reaction solvent at the time of polymerization of the present invention is not specifically limited, and the solvents include, for example, alcohol-based solvents such as methanol, ethanol, 2-propanol, 1-butanol, 2-methoxy ethanol, 3-methoxy propanol, and 1-methoxy-2-propanol; ketone-based solvents such as acetone, acetyl acetone, methyl ethylketone, methyl isobutylketone, methyl-t-butylketone, 2-pentanone, 3-pentanone, 2-heptanone, 3-heptanone, cyclopentanone and cyclohexanone; ester-based solvents such as ethyl acetate, propyl acetate, butyl acetate, isobutyl acetate, pentyl acetate, ethyl propionate, propyl propionate, butyl propionate, isobutyl propionate, propyleneglycol monomethyl ether acetate, methyl lactate, ethyl lactate and γ-butyrolactone; ether-based solvents such as tetrahydrofuran, dioxane, dimethoxyethane, diethoxyethane, diglyme, triglyme, tetraglyme, diisopropyl ether, dibutyl ether, ethyl propyl ether, anisole, phenetole and veratrole; aromatic hydrocarbon-based solvents such as benzene, toluene, xylene, mesitylene, ethylbenzene, diethylbenzene, propylbenzene and t-butyl benzene; halogen-based solvents such as methylene chloride, chloroform, bromoform and carbon tetrachloride; saturated hydrocarbon-based solvents such as ISOPAR M ((registered trademark) manufactured by Exxon Mobil Corporation) and liquid paraffin; amide-based solvents such as N-methylpyrrolidinone, dimethyl acetamide and dimethyl formamide; and mineral oil. The solvents may be used singly, or two or more kind of the solvents may be used in combination.

More preferable organic solvents are tetrahydrofuran, dioxane, dimethoxy ethane, diethoxy ethane, benzene, toluene, xylene, mesitylene, ethylbenzene, diethyl benzene, propyl benzene, t-butyl benzene, chloroform, bromoform, carbon tetrachloride, ISOPAR M (registered trademark), liquid paraffin and a mineral oil, and particularly preferable solvents are tetrahydrofuran, toluene, xylene, mesitylene and ISOPAR M.

The concentration of monomer at the time of polymerization in the solvent of the present invention is preferably from 20% by mass to 80% by mass, more preferably from 30% by mass to 70% by mass, and particularly preferably from 40% by mass to 60% by mass.

As the polymerization method of the polymer gel of the present invention, for example, a lump polymerizing method in which monomers and an initiator are dissolved in a solvent, and the solution is heated to be polymerized, and a dropping polymerizing method in which a solution of monomer and an initiator is added dropwise to a heated solvent over 0.5 to 10 hours, may be exemplified, and the lump polymerizing method is preferable.

As the method of taking out the polymer gel after polymerization reaction, in general, the polymer gel can be taken out by being scraped out physically, because the gel is in the state where the gel is swollen by absorbing almost whole reaction solvents at the end of polymerization. After taking out the swollen gel, an operation such as the suction filtration, decantation and centrifugal separation for removing an excess solvent is preferably performed, and the suction filtration is particularly desirable. However, in the case where the filtration is difficult due to clogged filter paper in the suction filtration, removal of the solvent by the centrifugal separation is also desirable.

For the purpose of removing unreacted monomer component, after taking out the gel in a swollen state, it is desirable to wash the swollen gel with the same solvent as the reaction solvent by the suction filtration or centrifugal separation.

After washing the swollen gel obtained in the above, the swollen gel is preferably dried in order to remove the residual solvent. The drying temperature is preferably from 50° C. to 200° C., more preferably 60° C. to 180° C., and further more preferably 70° C. to 150° C. In addition, in order to shorten drying time, the swollen gel may be dried under reduced pressure.

In what follows, an example of the scheme of the solution polymerization method is described, as a specific example of the synthetic method of polymer gel. The detailed synthetic method will be described later in the examples.

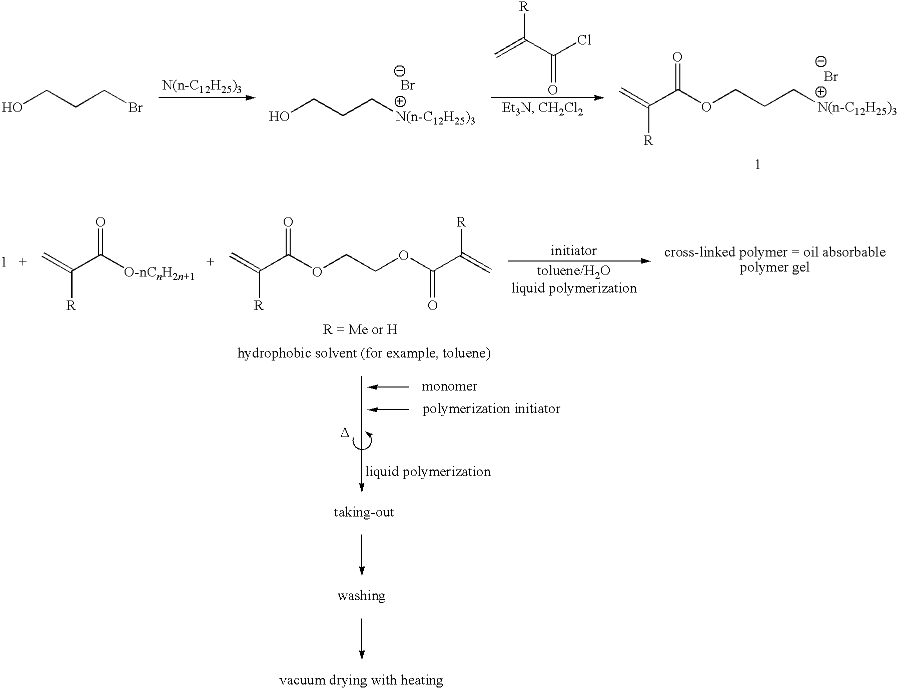

The block copolymer represented by the Formula (1) or (3) may be used for the gel of the present invention. In this case, owing to the self-organization by the electrostatic interaction among the hydrophilic moieties and the hydrophobic interaction among hydrophobic moieties, the gel may have a structure where the hydrophilic moieties and hydrophobic moieties are regularly arrayed, or localized in the inside of the gel particles.

The usage form of the polymer gel of the present invention is not particularly restricted, but a variety of forms such as particle, block, film, indefinite and fibrous forms may be used. The particle form is not particularly restricted, but spherical, elliptic, polyhedral, porous, fibrous, star-shaped, needle-shaped and hollow shapes may be used.

Further, in order to speed up the absorption of liquid by the polymer gel, it is desirable to make the polymer gel porous so that the penetration and effusion of liquid are facilitated. For example, swollen polymer gel is freeze-dried so that the polymer gel is made porous.

<Oil Absorbent>

The oil absorbent of the present invention can be formed from the polymer gel. The oil absorbent of the present invention can be suitably used for absorbing a liquid such as various oils, hexane and toluene with a dielectric constant of 10 or less to swell the polymer gel.

To the oil absorbent of the present invention, may be added ultraviolet absorbers such as a benzophenone-based, benzotriazole-based and benzoate-based ultraviolet absorbers; antioxidants such as a phenol-based, an organic sulfur-based, a phosphorus-based and an amine-based antioxidant; photostabilizers; inorganic pigments such as diatom earth, talc, kaolin, calcined kaolin, heavy calcium carbonate, precipitated calcium carbonate, magnesium carbonate, zinc oxide, aluminum oxide, aluminum hydroxide, magnesium hydroxide, titanium dioxide, barium sulfate, zinc sulfate, amorphous silica, and amorphous calcium silicate and colloidal silica; organic pigments such as a melamine resin filler, a urea-formalin resin filler, polyethylene powder and nylon powder; higher fatty acid metal salts such as zinc stearate and calcium stearate; higher fatty acid amides such as stearamide; slipping agents such as paraffin, polyethylene wax, oxidized polyethylene and caster wax, surfactants including anionic and nonionic compounds with a high molecular weight; dyes for dying and fluorescent dyes, defoaming agents, leveling agents, antiseptics, photodegradable catalysts such as titanium oxide, metal complex catalysts, ultraviolet absorbers and stabilizers such as an antioxidant.

The oil absorbent of the present invention can be manufactured by a simple manufacturing method as compared with conventional oil absorbents, which is, for example, formed by hydrophobicizing a hydrophilic gel manufactured by a sol-gel method. Specifically, the oil absorbent of the present invention can be manufactured by a single process which is radical polymerization reaction. Naturally, other processes may be added to the process of the present invention.

The oil absorbent of the present invention is capable of absorbing oil without troublesome operations such as heating or mixing being required at the time of oil absorption. The oil absorbent of the present invention has a high shape-maintainability and oil-holding property, and the recovery operation after oil absorption is easy.

The polymer gel of the present invention does not absorb water, and therefore can absorb only oil selectively, in a mixed system of water and oil such as oils for industrial use such as gasoline, heavy fuel oil, crude oil, kerosene, gas oil, and ISOPER M (registered trademark), and oils for home cooking use such as salad oil, rapeseed oil, soybean oil and olive oil. Accordingly, for example, it becomes possible to collect selectively only crude oil spilled on the sea surface.

Moreover, the oil absorbent of the present invention shows higher oil absorbability as compared with that of the conventional polymer-based oil absorbents. Accordingly, when the oil absorbent of the present invention absorbs and collects the same quantity of oil, the amount of the oil absorbent (polymer gel) to be used is smaller than that of conventional absorption gels, leading to a lower environmental load from the viewpoint of waste material.

The configuration of the oil absorbent of the present invention is sterically compact and has less weight before absorbing oil, and therefore, it is also still possible to prepare and arrange it as a home use/industrial use waste-oil-treatment agent, an oil seal agent and an oil sustained-release substrate (fragrance substrate) in preparation for an oil spillage accident from a ship or a gas station.

### EXAMPLES

Hereinafter, the present invention will be described with reference to the following examples in detail. Various modifications and changes of materials, reagents, quantity and ratio of materials and mode of operation as described in the examples may be made, without departing from the spirit and scope of the present invention. Accordingly, the present invention is not limited to the examples.

### Synthetic Example 1

### Synthesis of Monomer

The following compound-1 was synthesized according to the following scheme.

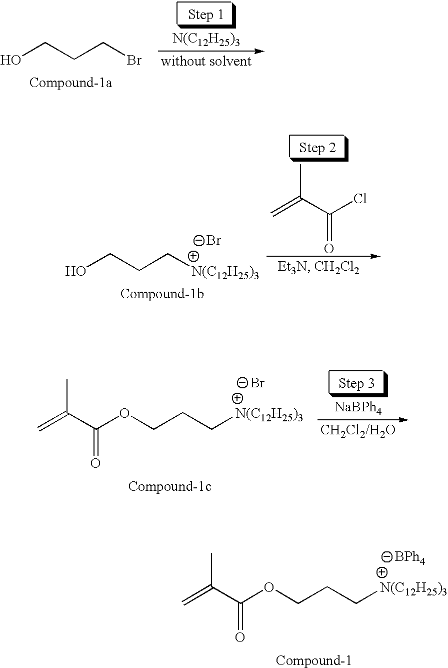

### (Step 1)

A mixture of 3-bromo-1-propanol (the above compound-1a) (19.9 g, 143 mmol) and tri-n-dodecylamine (149 g, 286 mmol) was stirred without solvent at 120° C. for 9 hours. After a white solid obtained by being cooled to room temperature was filtered, the white solid washed with ethyl acetate, and compound-1b was obtained quantitatively.

### (Step 2)

The thus obtained compound-1b (31.4 g, 47.5 mmol) and 5.77 g (57.0 mmol) of triethylamine were dissolved in 147 ml of methylene chloride, and 5.46 g (52.2 mmol) of methacryloyl chloride was added thereto dropwise slowly with ice-cold cooling under a nitrogen atmosphere. After stirring at room temperature for 2 hours, 200 ml of water was added thereto, and a liquid separatory operation was performed. Thereafter, the solvent was distilled away, and compound-1c was obtained.

### (Step 3)

The thus obtained compound-1c (26.9 g, 36.9 mmol) was dissolved in 150 ml of methylene chloride, 28.3 g (82.8 mmol) of sodium tetraphenylborate and 75 ml of water were added thereto, and the resultant two phase system was stirred at room temperature for 7 hours. After 200 ml of water was added to the reaction liquid, a phase separatory operation performed with methylene chloride. The extract was washed with water, and compound-1 was obtained.

### Synthetic Example 2

### Synthesis of Monomer

The following compound-2 was synthesized according to the following scheme.

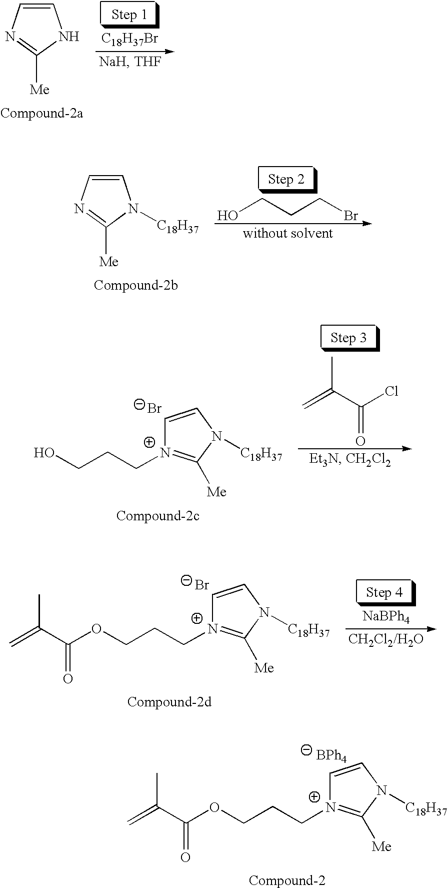

(Step 1)

The above compound-2a (10.0 g, 122 mmol) was dissolved in 240 ml of tetrahydrofuran (THF) solvent, thereafter, 4.87 g (122 mmol) of sodium hydride was slowly added thereto with stirring with ice-cold cooling under a nitrogen atmosphere, and the mixture was stirred with ice-cold cooling for 30 minutes. After adding 42.6 g (128 mmol) of 1-bromooctadecane thereto at room temperature, the mixture was stirred at 60° C. for 4 hours. After 300 ml of water was added to the reaction solution, an extraction was performed with ethyl acetate, and the extract was washed with saturated sodium chloride solution, and was dried with anhydrous magnesium sulfate. After distilling away the solvent, the product was purified with silica gel column chromatography (solvent: hexane/ethyl acetate=10/1), and 40.7 g of compound-2b was obtained.

(Step 2)

The compound-2b (40.1 g, 120 mmol) thus obtained and 3-bromo-1-propanol (16.7 g, 120 mmol) were stirred without solvent at 110° C. for 10 hours. After cooling the reaction solution to room temperature, the obtained wax-like solid was washed with toluene, and purified with silica gel column chromatography, and compound-2c was obtained.

(Step 3)

The obtained compound-2c (36.3 g, 76.6 mmol) and 9.23 g (91.9 mmol) of triethylamine were dissolved in 150 ml of methylene chloride, and 8.41 g (80.5 mmol) of methacryloyl chloride was added thereto dropwise slowly with ice-cold cooling under a nitrogen atmosphere. After stirring at room temperature for 2 hours, 150 ml of water was added thereto, and a liquid separatory operation was performed. Thereafter, the solvent was distilled away, and compound-2d was obtained.

(Step 4)

The compound-2d (38.5 g, 71.1 mmol) thus obtained was dissolved in 170 ml of methylene chloride, 31.6 g (92.4 mmol) of sodium tetraphenylborate and 60 ml of water were added thereto, and the resultant two phase system was stirred at room temperature for 9 hours. After 200 ml of water was added to the reaction liquid, a phase separatory operation performed with methylene chloride. The extract was washed with water, and compound-2 was obtained.

### Example 1

### Preparation of Polymer Gel 1

An oil absorptive polymer gel 1 was prepared by the solution polymerization method as described below.

As a monomer, 1.89 g (1.95 mmol) of the compound-1 synthesized in the synthetic example 1 (x=29.7 mole % in Formula (1)), 1.54 g (4.55 mmol) of octadecyl methacrylate (y=69.3 mole %), and 12.9 mg (0.065 mmol) of ethyleneglycol dimethacrylate (z=1.0 mole %) as a cross-linking agent were dissolved in 3 ml of degassed toluene, and the mixture was stirred at room temperature under a nitrogen atmosphere for 15 minutes. Thereafter, 16.1 mg (0.065 mmol) of V-65 ((trade name) manufactured by Wako Pure Chemical Industries, Ltd.) as a polymerization initiator was added to the reaction solution, and the mixture was stirred at 60° C. under a nitrogen atmosphere for 5 hours.

Thereafter, the thus obtained gel was washed with toluene, and was subjected to vacuum drying with heating, and a dry solid product of gel (polymer gel 1) was obtained.

<Evaluation of Oil Absorptivity>

The dry solid product of the obtained polymer gel 1 was immersed in an industrial use oil (ISOPAR M ((registered trademark) manufactured by Exxon Mobil Corporation), dielectric constant ∈=1.9) at 25° C., and the amount of oil absorption was assessed. Here, the amount of oil absorption means an amount of oil absorption per one gram of dry gel;

Amount of oil absorption (Q)=(mass of swollen gel−mass of dry gel)/mass of dry gel.

The amount of oil absorption after one-hour immersion of the polymer gel 1 was 10.5, and the amount of oil absorption after 24-hour immersion was 15.0.

### Example 2

### Preparation of Polymer Gel 2

A dry solid product of a polymer gel (polymer gel 2) having PEO groups was prepared in a manner similar to Example 1 except that the monomer component Example 1 was changed to the following composition.

### (Monomer Composition)

| | |
|---|---|
| Compound-2 synthesized in the | 1.89 g (1.95 mmol, x = 29.7 mole %) |
| synthesizing example 2 | |
| Octadecylmethacrylate | 1.21 g (3.58 mmol, y = 54.5 mole %) |
| Ethyleneglycol dimethacrylate | 12.9 mg (0.065 mmol, z = 1.0 mole %) |
| as a cross-linking agent | |
| Ethyleneglycol monomethyl | 269 mg (0.975 mmol, 14.8 mole %) |
| ether monometacrylate | |
| (NK ester M40G (trade name) | |
| manufactured by Shin-Nakamura | |
| Chemical Co., Ltd.) | |

<Evaluation of Oil Absorptivity>

When the amount of oil absorption by the obtained polymer gel 2 was measured in a manner similar to Example 1, the amount of oil absorption after one-hour immersion of the polymer gel 2 was 16.5, and the amount of oil absorption after 24-hour immersion was 21.0.

### Example 3

The oil absorptive polymer gel 3 was prepared by the solution-polymerization method as described below:

First, 4-(methacryloyl)butanoic acid methyl ester was synthesized in accordance with the method as recited in J. Mex. Chem. Soc. 2006, 50 (4), pp 164-174.

Subsequently, 3.67 g (19.7 mmol) of the synthesized 4-(methacryloyl)butanoic acid methyl ester as a monomer (x=30.0 mole % in Formula (3)), 15.4 g (45.6 mmol) of octadecyl methacrylate (y=69.5 mole %), and 129 mg (0.65 mmol) of ethyleneglycol dimethacrylate (z=0.5 mole %) as a cross-linking agent were dissolved in 3 ml of degassed toluene, and the mixture was stirred at room temperature under a nitrogen atmosphere for 15 minutes. Thereafter, 161 mg (0.65 mmol) of V-65 ((trade name) manufactured by Wako Pure Chemical Industries, Ltd.) as a polymerization initiator was added to the reaction solution, and the mixture was stirred at 60° C. under a nitrogen atmosphere for 5 hours.

Thereafter, the methylcarboxylate moiety on the polymer gel of the obtained solid product was converted to lithium carboxylate in the presence of lithium iodide in a pyridine solvent in accordance with the method as recited in J. Mex. Chem. Soc. 2006, 50 (4) pp, 164-174.

Subsequently, 15 g of the obtained gel-like solid product was milled and immersed in 100 ml of methylene chloride, and further 30 g of tridodecyl methyl ammonium bromide was added thereto and was stirred at room temperature for 10 hours. The obtained gel-like solid product was washed with methylene chloride, water, ethanol and toluene, and a polymer gel containing 4-(methacryloyl) butanoic acid tridodecyl methyl ammonium as a monomer unit was obtained.

Thereafter, the thus obtained gel was washed with toluene, and was subjected to vacuum drying with heating, and a dry solid product of gel (polymer gel 3) was obtained.

<Evaluation of Oil Absorptivity>

When the amount of oil absorption by the obtained polymer gel 3 was measured in a manner similar to Example 1, the amount of oil absorption after one-hour immersion of the polymer gel 3 was 12.0, and the amount of oil absorption after 24-hour immersion was 17.5.

### Comparative Example 1

A norbornene polymer was prepared in accordance with Example 1 of JP-A No. 6-279571.

<Evaluation of Oil Absorptivity>

When the amount of oil absorption by the obtained norbornene polymer was measured in a manner similar to Example 1, the amount of oil absorption after one-hour immersion of the norbornene polymer was 8.0 and the amount of oil absorption after 24-hour immersion of the norbornene polymer was 11.0.

### Example 4

Compounds 41-44 having a quaternary ammonium substituted with an alkyl group were prepared in a manner similar to the synthetic example 1 except that n-tridodecylamine (286 mmol) used in the step 1 of the synthetic example 1 was replaced with tri-n-decyl amine (286 mmol), tri-n-octadecyl amine (286 mmol), tri-n-dococyl amine (286 mmol), or tri-n-hexylamine (286 mmol).

Polymer gels 41 to 44 were prepared in a manner similar to Example 1 except that the compound 1 was changed to the above compounds 41 to 44. The evaluation of absorptivity of these polymer gels was performed similar to that of Example 1. The evaluation results are shown in Table 1.

TABLE 1

| | Number of carbons | Amount of | | |
|---|---|---|---|---|
| | of alkyl group | oil absorption | | |
| Polymer | bonded to nitrogen atom of | after | after | |
| Gel | quaternary ammonium ion | one hour | 24 hour | Remarks |
| 1 | 12 | 10.5 | 15.0 | Invention |
| 41 | 10 | 10.0 | 14.0 | Invention |
| 42 | 18 | 12.0 | 16.5 | Invention |
| 43 | 22 | 12.5 | 21.0 | Invention |
| 44 | 6 | 7.0 | 9.0 | Comparative |
| | | | | Example |

As shown in Table 1, as compared with the comparative polymer gel 44, the oil absorptivity of the polymer gel 1 and 41 to 43 are markedly increased.

### Example 5

### Preparation of Polymer Gels 51 to 59

A dry solid product of a polymer gel (polymer gel 51) was prepared in a manner similar to Example 1 except that the monomer component was changed to the following composition.

(Monomer Composition)

| | |
|---|---|
| Compound-1 of Synthetic | 1.89 g (1.95 mmol, x = 29.7 mole %) |
| Example 1 | |
| Tetradecyl methacrylate | 1.29 g (4.55 mmol, y = 69.3 mole %) |
| Ethyleneglycol dimethacrylate | 12.9 mg (0.065 mmol, z = 1.0 mole %) |

Further, polymer gels 52 to 59 were prepared in a manner similar to polymer gel 51 except that the monomer ratios x, y and z of the polymer gel 51 were changed to the monomer ratios as shown in the following table 2.

<Evaluation of Oil Absorptivity>

When the amount of oil absorption by the obtained polymer gels 51 to 59 was measured in a manner similar to Example 1, the amounts oil absorption after 24-hour immersion were the values shown in the following table 2. In addition, the polymer gel 52 with a low cross-linking degree was partly dissolved in the solvent.

TABLE 2

| Polymer Gel | x | y | z | Amount of oil absorption | |
|---|---|---|---|---|---|
| 51 | 29.7 | 69.3 | 1.0 | 15.8 | Invention |
| 52 | 29.7 | 68.6 | 0.3 | 18.4 | Invention |
| 53 | 29.7 | 67.3 | 3.0 | 10.2 | Comparative |
| | | | | | Example |
| 54 | 29.7 | 69.7 | 0.6 | 18.0 | Invention |
| 55 | 29.7 | 69.5 | 0.8 | 17.7 | Invention |
| 56 | 29.7 | 68.8 | 1.5 | 15.1 | Invention |
| 57 | 29.7 | 68.3 | 2.0 | 14.4 | Invention |
| 58 | 29.7 | 68.0 | 2.3 | 14.0 | Invention |
| 59 | 29.7 | 67.8 | 2.5 | 13.5 | Invention |

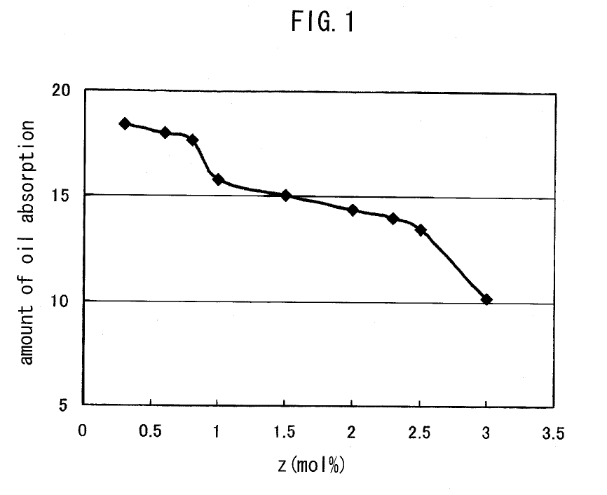

The results of Table 2 are graphed as shown in FIG. 1. As shown in FIG. 1, the oil absorptivity is excellent when z is 2.5 mole % or less, and more excellent when z is 0.8 mole % or less.

### Example 6

Using the polymer gels 51 to 54 obtained in Example 51, the solvent were changed to the solvents shown in Table 3 and the amounts of oil absorption after 24-hour immersion were measured. The results are shown in Table 3.

TABLE 3

| | | Amount of oil absorption | | | |
|---|---|---|---|---|---|
| | | | | Polymer gel | |
| Solvent | | Polymer gel | Polymer gel | 53 | Polymer gel |
| | Dielectric | 51 | 52 | Comparative | 54 |
| | constant ε | Invention | Invention | Example | Invention |
| ISOPAR M | 1.9 | 15.8 | 18.4 | 10.2 | 18.0 |
| Hexane | 2.0 | 16.2 | 18.9 | 11.0 | 18.8 |
| Toluene | 2.4 | 19.7 | 20.1 | 14.7 | 20.5 |
| Tetrahydrofuran | 7.6 | 17.5 | 19.0 | 12.4 | 19.8 |
| Ethanol | 21 | 3.01 | 2.8 | 1.90 | 3.4 |

As shown in Table 3, the polymer gels 51, 52 and 54 excellently absorbed the low polar solvents having a low dielectric constant. In particular, toluene having a dielectric constant of 2.4, and tetrahydrofuran having a dielectric constant of 7.6 were absorbed in the polymer gels 51, 52 and 54 at a high amount of oil absorption.

### Example 7

A dry solid product of polymer gel (polymer gel 7) was prepared in a manner similar to Example 1 except that the compound-1 was changed to the compound 1c.

The polymer gels 1 and 7 were immersed in the solvent shown in the following table 4 for 24 hours, and the amount of oil absorption was measured. The results are shown in Table 4.

TABLE 4

| | | Amount of oil absorption | |
|---|---|---|---|
| | | | Polymer gel 7 |
| Solvent | | Polymer gel 1 | Counter |
| | Dielectric | Counter anion: BPh₄⁻ | anion: Br⁻ |
| | constant ε | Invention | Invention |
| ISOPAR M | 1.9 | 15.0 | 13.6 |
| Hexane | 2.0 | 14.5 | 13.5 |
| Toluene | 2.4 | 20.2 | 18.1 |
| Tetrahydrofuran | 7.6 | 19.6 | 17.9 |
| Ethanol | 21 | 4.2 | 3.5 |

As shown in Table 4, the low polar solvents having a low dielectric constant were well absorbed in the polymer gels 1 and 7.

Furthermore, the amount of oil absorption in the polymer gel 1 having a tetraphenyl borate ion (BPh₄⁻) as a counter anion was higher than that of the polymer gel 7 having a bromo ion (Br⁻) as a counter anion for any of low polar solvents

### Example 8

In the compound 2 which includes a heterocyclic cation monomer as a monomer unit of Example 2, the kind of cationic group or the kind of counter anion was changed, and the following compounds 81 to 85 were obtained. The polymer gels 81 to 85 were prepared in a manner similar to Example 2 except that the compound 2 was changed to the compounds 81 to 85. The oil absorptivity in the polymer gels 81 to 85 of was assessed in a similar manner to that of Example 1. The evaluation results are shown in Table 5.

TABLE 5

| | | | Amount of oil absorption |
|---|---|---|---|
| Polymer gel | Cationic group | Counter anion | (24 hours) |
| 2 | Imidazolium ion | BPh₄⁻ | 21.0 |
| 81 | Imidazolium ion | Br⁻ | 18.0 |
| 82 | Imidazolium ion | TFPB⁻ | 22.3 |
| 83 | Piperidinium | BPh₄⁻ | 19.5 |
| 84 | Pyridinium | BPh₄⁻ | 18.5 |
| 85 | Pyrrolidinium | BPh₄⁻ | 16.0 |

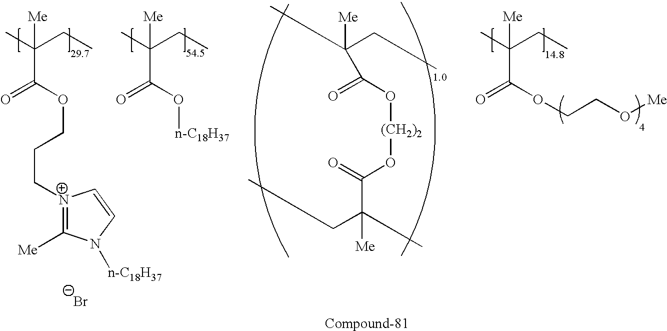

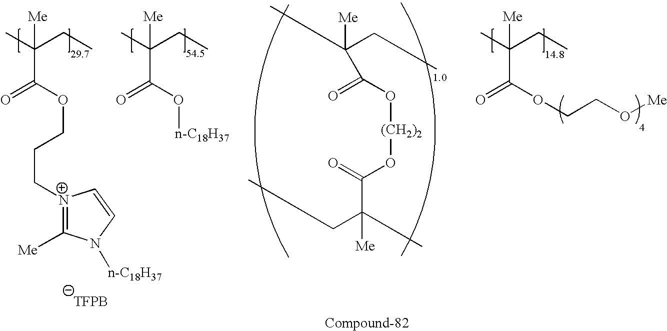

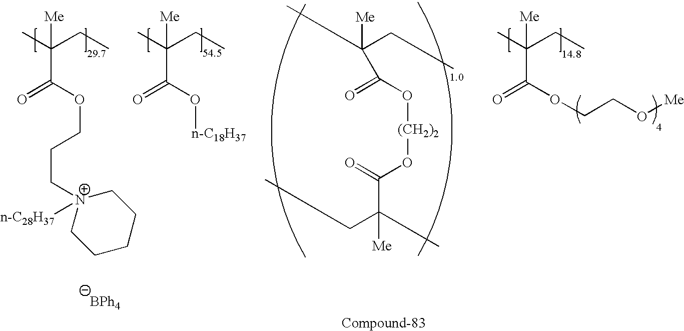

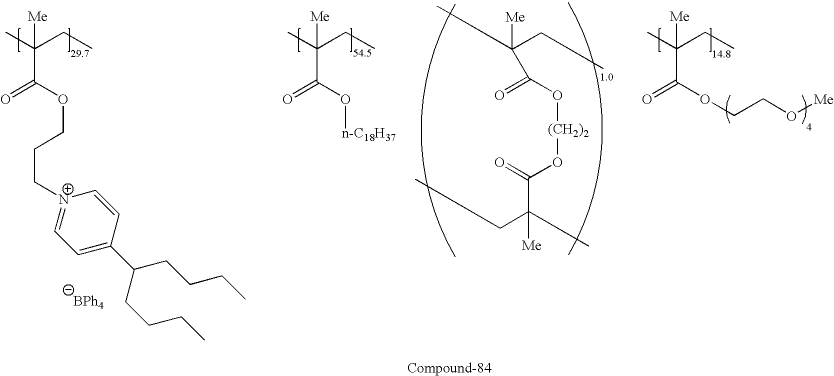

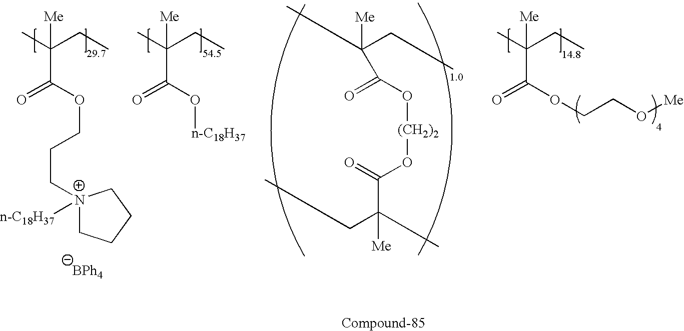

### Example 9

Polymer gels 86 to 92 were prepared in a manner similar to Example 1 except that the kind or ratio of monomers was changed as follows.

The polymer gels were assessed in a similar manner to that of Example 1. The evaluation results are shown in Table 6.

TABLE 6

| | Amount of oil sbsorption | Amount of oil absorption | |
|---|---|---|---|
| Polymer gel | after one hour | after 24 hour | Remarks |
| 86 | 14.0 | 20.5 | Invention |
| 87 | 14.5 | 21.0 | Invention |
| 88 | 13.5 | 19.0 | Invention |
| 89 | 15.0 | 20.0 | Invention |
| 90 | 12.0 | 15.5 | Invention |
| 91 | 11.0 | 15.0 | Invention |
| 92 | 13.5 | 19.0 | Invention |

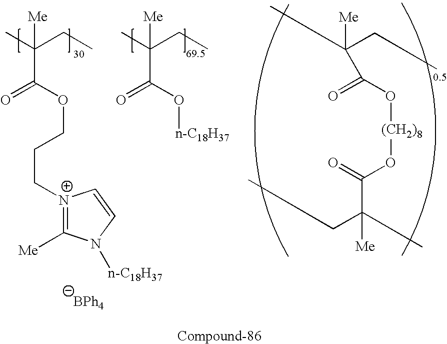

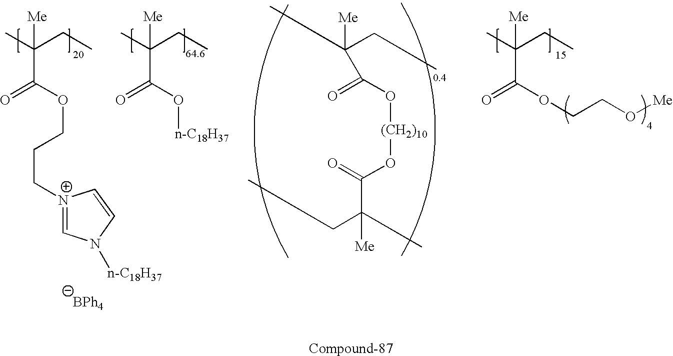

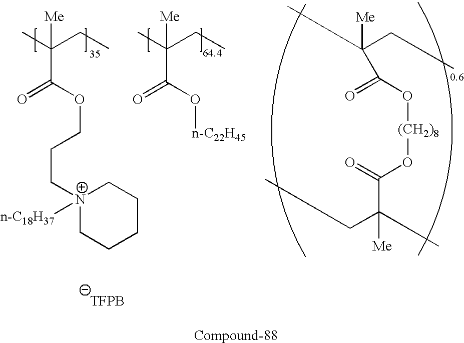

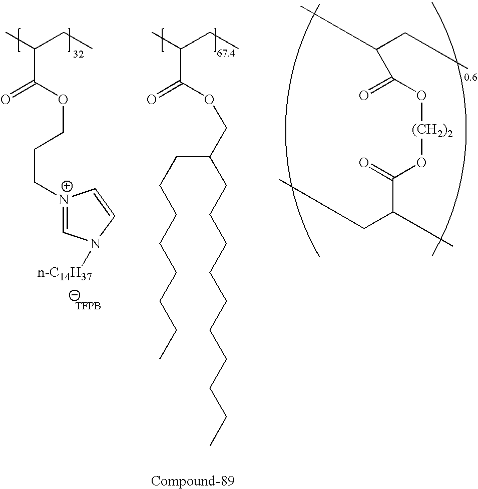

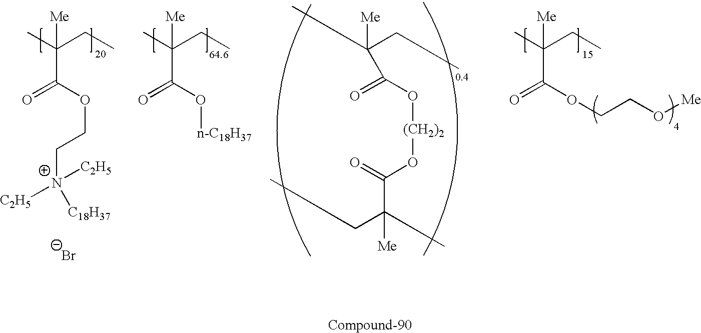

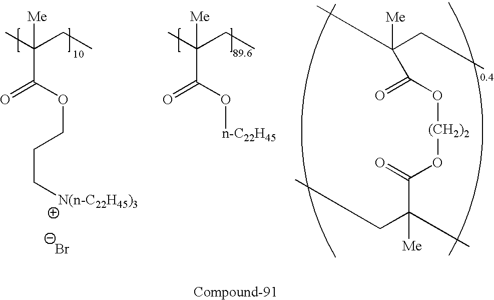

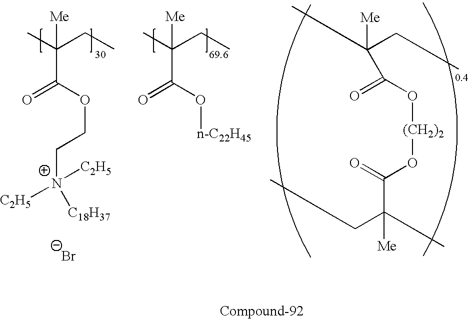

As shown in Table 6, the polymer gels within the scope of the present invention show a high amount oil absorption, even if the monomer kind or the monomer ratio was changed.

### Example 10

Polymer gels 101 to 106 were prepared in a manner similar to Example 3 except that the anionic monomer was changed to the following compounds 101 to 106.

The oil absorptivity of the polymer gels were assessed in a similar manner to that of Example 1. The evaluation results are shown in Table 7.

TABLE 7

| Polymer gel | | | Amount of oil absorption |
|---|---|---|---|
| Polymer gel No. | Anionic group | Counter cation | (After 24 hours) |
| 3 | Carboxylic acid | Ammonium | 17.5 |
| 101 | Carboxylic acid | Sodium | 13.9 |
| 102 | Phosphoric acid | Ammonium | 14.5 |
| 103 | Carboxylic acid | Imidazolium | 16.0 |
| 104 | Sulfonic acid | Ammonium | 14.0 |
| 105 | Boric acid | Ammonium | 13.5 |
| 106 | Boric acid | Imidazolium | 15.0 |

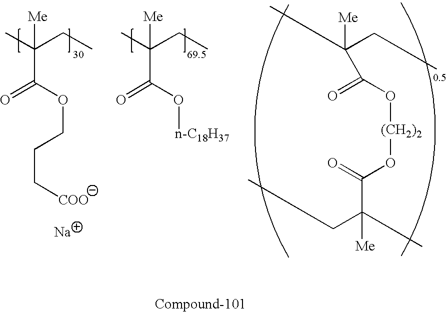

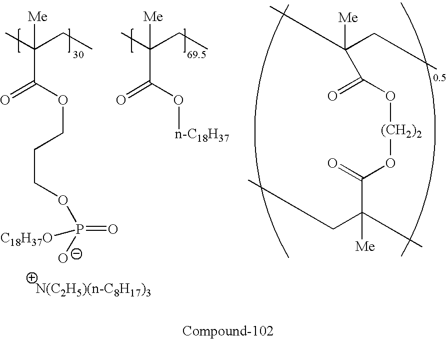

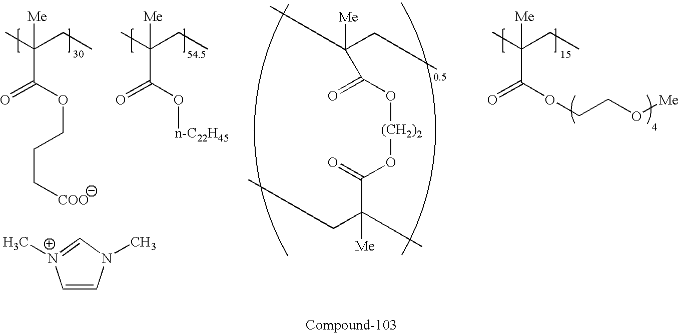

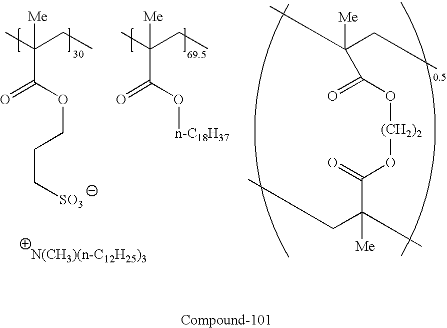

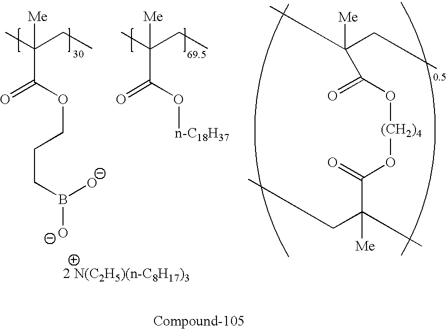

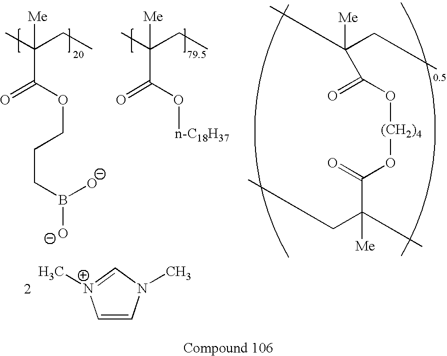

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

All publications, patent applications, and technical standards mentioned in this specification are herein incorporated by reference to the same extent as if each individual publication, patent application, or technical standard was specifically and individually indicated to be incorporated by reference.

What is claimed is:

1. A polymer compound having a repeating structure represented by the following Formula (1): 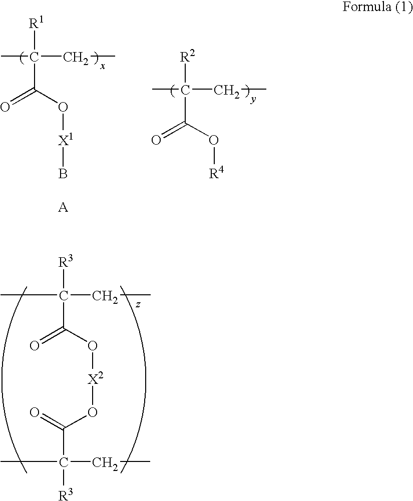
wherein in Formula (1), R¹, R² and R³ each independently represent a hydrogen atom or an alkyl group; R⁴ represents a straight-chained, branched or cyclic alkyl group having 10 or more carbon atoms; X¹ and X² each independently represent a divalent linking group; B represents a quaternary ammonium ion, in which at least one alkyl group having 10 or more carbon atoms is bonded to the nitrogen atom of the quaternary ammonium ion, or a cation with delocalized charge; A represents a counter anion therefor; and x, y and z each represent mole %, and satisfy the following conditions; 0<x≦90, 0<y≦90, 0<z≦2.5, and 70≦x+y+z≦100.

2. The polymer compound according to claim 1, wherein z in Formula (1) is 0.8 mole % or less.

3. The polymer compound according to claim 1, wherein B in Formula (1) is a heterocyclic cation with delocalized charge.

4. The polymer compound according to claim 1, wherein B in Formula (1) is an imidazolium ion, a pyridinium ion, a piperidinium ion, a pyrrolidinium ion or an oxazolium ion.

5. The polymer compound according to claim 1, wherein B in Formula (1) is a cation represented by the following Formula (2): 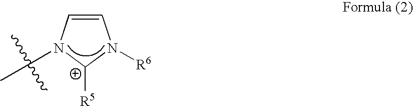
wherein in Formula (2), R⁵ represents a hydrogen atom, or a straight-chained, branched or cyclic alkyl group; R⁶ represents a straight-chained, branched or cyclic alkyl group; and the wavy line represents the bonding position to X¹.

6. The polymer compound according to claim 1, wherein A in Formula (1) is a halogen ion, a phosphoric acid ion, a phosphonic acid ion, a carboxylic acid ion, a sulfite ion, a sulfuric acid ion, PF₆, SbF₆, N(SO₂CF₃)₂, ClO₄, SO₃CF₃, or Anion (I) shown below: 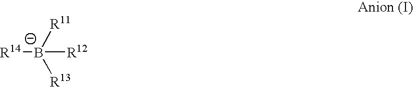
wherein in Anion (I), R¹¹, R¹², R¹³ and R¹⁴ each independently represent an aromatic ring group which may have one or plural substituents, a halogen atom or an alkyl group which may have a substituent.

7. The polymer compound according to claim 1, wherein R⁴ in Formula (1) represents a straight-chained alkyl group which does not have a substituent.

8. The polymer compound according to claim 1, wherein x in Formula (1) is from 1 mole % to 50 mole %.

9. The polymer compound according to claim 1, wherein y in Formula (1) is from 50 mole % to 90 mole %.

10. The polymer compound according to claim 1, wherein the polymer compound has a repeating structure represented by the following Formula (1-1): 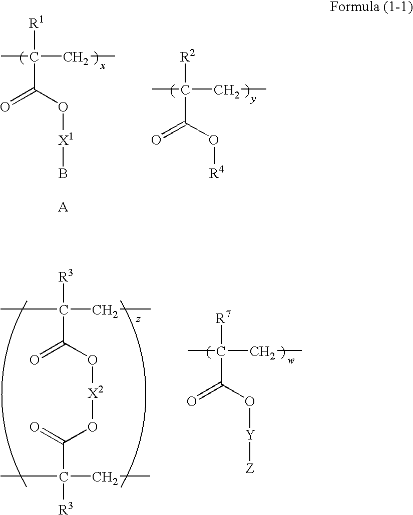
wherein in Formula (1-1), R¹, R², R³, R⁴, X¹, X², A and B are synonymous with R¹, R², R⁴, X¹, X², A and B in Formula (1), respectively; R⁷ is synonymous with R¹ to R³ in Formula (1); Y represents a polyethyleneoxy group or a polypropyleneoxy group; Z represents a straight-chained, branched or cyclic alkyl group, or a hydrogen atom; and x, y, z and w each represent mole %, and satisfy the following conditions; 0<x≦90, 0<y≦90, 0<z≦2.5, 0<w<30 and 70≦x+y+z<100.

11. A polymer compound having a repeating structure represented by the following Formula (3): 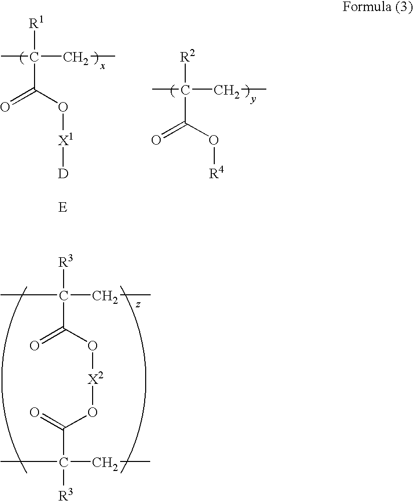
wherein in Formula (3), R¹, R² and R³ each independently represent a hydrogen atom or an alkyl group; R⁴ represents a straight-chained, branched or cyclic alkyl group having 10 or more carbon atoms; X¹ and X² each independently represent a divalent linking group; D represents a phosphoric acid ion which may be alkyl-substituted, a phosphonic acid ion which may be alkyl-substituted, a carboxylic acid ion, a sulfite ion, a sulfuric acid ion, the following Anion (II) which may be alkyl-substituted, the following Anion (III) which may be alkyl-substituted, or the following Anion (IV); E represents a counter anion therefor; and x, y and z each represent mole %, and satisfy the following conditions; 0<x≦90, 0<y≦90, 0<z≦2.5, and 70≦x+y+z≦100; 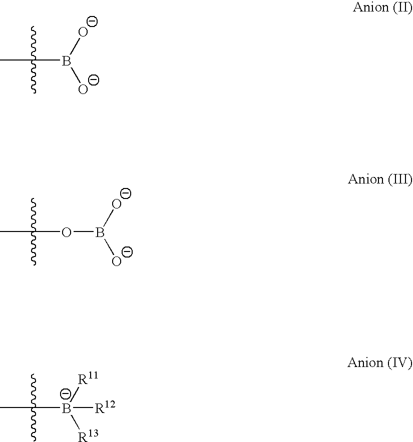
wherein the wavy lines in Anion (II), (III) and (IV) represent the bonding position to X¹ in Formula (3); and in Anion (IV), R¹¹, R¹² and R¹³ each independently represent an aromatic ring group which may have a substituent, a halogen atom or an alkyl group which may have a substituent.

12. The polymer compound according to claim 11, wherein E in Formula (3) is a quaternary ammonium ion or a cation with delocalized charge.

13. The polymer compound according to claim 11, wherein E in Formula (3) is a heterocyclic cation represented by the following Formula (4): 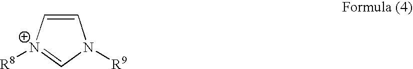
wherein in Formula (4), R⁵ and R⁹ each independently represent a straight-chained, branched or cyclic alkyl group.

14. The polymer compound according to claim 11, wherein R⁴ in Formula (3) represents a straight-chained alkyl group which does not have a substituent.

15. The polymer compound according to claim 11, wherein z in Formula (3) is 0.8 mole % or less.

16. The polymer compound according to claim 11, wherein x in Formula (3) is from 1 mole % to 50 mole %.

17. The polymer compound according to claim 11, wherein y in Formula (3) is from 50 mole % to 90 mole %.

18. The polymer compound according to claim 11, wherein the polymer compound has a repeating structure represented by the following Formula (3-1): 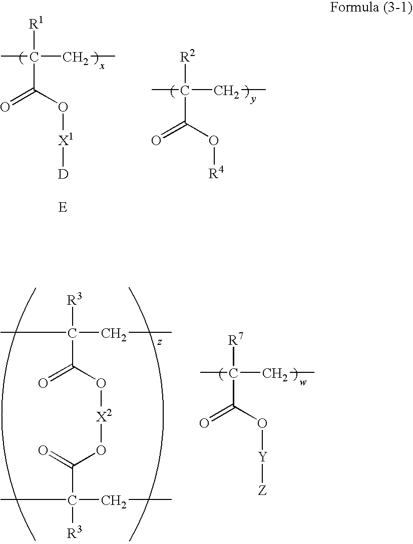
wherein in Formula (3-1), R¹, R², R³, R⁴, X¹, X², D and E are synonymous with R¹, R², R³, R⁴, X¹, X², D and E in Formula (3), respectively; R⁷ is synonymous with R¹ to R³ in Formula (3); Y represents a polyethyleneoxy group or a polypropyleneoxy group; Z represents a straight-chained, branched or cyclic alkyl group, or a hydrogen atom; and x, y, z and w each represent mole %, and satisfy the following conditions; 0<x≦90, 0<y≦90, 0<z≦2.5, 0<w<30 and 70≦x+y+z<100.

19. An oil absorbent containing the polymer compound according to claim 1.

20. An oil absorbent containing the polymer compound according to claim 11.
